(19) United States
(12) Patent Application Publication
(10) Pub. No.: US 2025/0371778 A1
(43) Pub. Date: Dec. 4, 2025

(54) LOW-LATENCY AUDIO TO FACE ANIMATION WITH EMOTION DETECTION

(71) Applicant: NVIDIA Corporation, Santa Clara, CA (US)

(72) Inventors: Hugo Maxence Verjus, Zurich (CH); Zheng Liu, Los Altos, CA (US); Kaustubh Purandare, San Jose, CA (US); Joonwhee Park, Mountain View, CA (US)

(21) Appl. No.: 19/225,853

(22) Filed: Jun. 2, 2025

Related U.S. Application Data
(60) Provisional application No. 63/655,070, filed on Jun. 2, 2024.

(51) Int. Cl. G06T 13/20; G10L 25/63

(52) U.S. Cl. CPC G06T 13/205; G10L 25/63

(57) ABSTRACT

Apparatuses, systems, and methods for low-latency audio-to-face animation with emotion detection are disclosed herein. The system may receive a first audio stream associated with a first device and a second audio stream associated with a second device, and provide, concurrently, a first segment of the first audio stream and a second segment of the second audio stream as inputs to an emotion detection artificial intelligence (AI) model to obtain first emotion data and second emotion data. The system may then provide, concurrently, a third segment of the first audio stream with the first emotion data and a fourth segment of the second audio stream with the second emotion data as inputs to a face animation AI model to obtain first face pose data and second face pose data, and provide the first face pose data to the first device and the second face pose data to the second device.

### RELATED APPLICATIONS

This application claims the benefit of U.S. Application No. 63/655,070, filed Jun. 2, 2024, the entire contents of which are incorporated herein by reference.

### TECHNICAL FIELD

At least one embodiment pertains to artificial intelligence systems and techniques for low-latency audio processing to generate synchronized facial animations with emotion detection for digital avatars.

### BACKGROUND

Digital avatars in user-facing systems can include animated faces that match spoken audio, where converting input audio to appropriate mouth movements and emotional expressions can present technical challenges regarding processing time and latency. Existing systems may face difficulties with real-time performance, particularly when processing multiple audio streams simultaneously. These limitations can become noticeable in multi-user environments, potentially resulting in lag that may affect user experience and interaction with digital avatars.

### BRIEF DESCRIPTION OF DRAWINGS

Various embodiments in accordance with the present disclosure will be described with reference to the drawings, in which:

FIG. 1 is a block diagram of an example system architecture for low-latency audio-to-face animation with emotion detection, according to at least one embodiment;

FIG. 2 illustrates an example of audio data windows and inference processing for emotion detection and face animation artificial intelligence (AI) models, according to at least one embodiment;

FIG. 3A illustrates a timing diagram showing the processing of multiple audio segments at the beginning of an audio clip, according to at least one embodiment;

FIG. 3B illustrates a timing diagram showing the processing of multiple audio segments at the end of an audio clip, according to at least one embodiment;

FIG. 4 illustrates a processing pipeline for audio data preprocessing including re-chunking, resampling, and converting operations, according to at least one embodiment;

FIG. 5 illustrates a system architecture for emotion flow between audio-to-emotion and audio-to-face AI models using emotion mailboxes, according to at least one embodiment;

FIG. 6 illustrates an example implementation of a scalable pipeline architecture for processing multiple audio streams concurrently, according to at least one embodiment;

FIG. 7 illustrates an example of batch inference for processing multiple audio streams simultaneously through emotion detection and face animation AI models, according to at least one embodiment;

FIG. 8 is a flow diagram of a method for low-latency audio-to-face animation with emotion detection across multiple devices, according to at least one embodiment;

FIG. 9A illustrates inference and/or training logic, according to at least one embodiment;

FIG. 9B illustrates inference and/or training logic, according to at least one embodiment;

FIG. 10 illustrates an example data center system, according to at least one embodiment;

FIG. 11 illustrates a computer system, according to at least one embodiment;

FIG. 12 illustrates a computer system, according to at least one embodiment;

FIG. 13 illustrates at least portions of a graphics processor, according to one or more embodiments;

FIG. 14 illustrates at least portions of a graphics processor, according to one or more embodiments;

FIG. 15 is an example data flow diagram for an advanced computing pipeline, in accordance with at least one embodiment;

FIG. 16 is a system diagram for an example system for training, adapting, instantiating and deploying machine learning models in an advanced computing pipeline, in accordance with at least one embodiment; and

FIGS. 17A and 17B illustrate a data flow diagram for a process to train a machine learning model, as well as client-server architecture to enhance annotation tools with pre-trained annotation models, in accordance with at least one embodiment.

### DETAILED DESCRIPTION

Aspects of the present disclosure are related to low-latency audio processing to generate synchronized facial animations with emotion detection for digital avatars. Some user-facing systems can include digital avatars that interact with the user. In some cases, the digital avatar can be depicted with a body that can be animated, such as an animated face, hands, arms, and/or the like. For example, when the digital avatar is “speaking” to the person (e.g., when a system displaying the digital avatar is playing audio for the user to hear), a mouth of the digital avatar may be animated to match the words that are being “spoken.”

In some cases, the digital avatar can be configured to mirror other content provided as input. For example, a user may provide an input audio recording that the digital avatar should speak. Based on the input audio recording, animations for the digital avatar's face can be determined so the mouth of the digital avatar matches the words being spoken. In some cases, emotion information can be extracted from the input audio recording, and the emotion information can be used to add additional animations to the digital avatar's face.

Converting input audio to emotion data and using that emotion data to generate face animations can require processing time, which can lead to latency or lag if the digital avatar is being viewed in real time or near real time.

Aspects of the present disclosure address the above and other deficiencies by providing systems and techniques that allow for low-latency audio to face animation with emotion detection. An input audio can first be provided to an “audio to emotion” (Audio2Emotion) artificial intelligence (AI) model that can generate emotion data based on a given input audio. The output emotion data and the original input audio can be provided to an “audio to face” (Audio2Face) AI model that can generate face animation data based on the given input audio and the provided emotion data. For example, if the emotion data indicates an angry emotion, the Audio2Face model may generate face animation data that includes furrowing the eyebrows of the digital avatar.

A sliding window may be used to grab segments of the input audio data to provide as inputs to the AI models. Each AI model (e.g., Audio2Emotion, Audio2Face, etc.) may have a different window size. For example, Audio2Emotion may be configured with a window size of 1875 milliseconds (ms). So, given an audio stream of 2000 ms, the Audio2Emotion AI model may receive a 1875 ms segment of the audio stream as an input. For example, the sliding window for a first segment may be centered on 937.5 ms of the audio stream and may include audio from time 0 ms to 1875 ms to fill the sliding window. The sliding window may then advance by a predetermined amount (e.g., 1 ms, 5 ms, 30 ms, 100 ms, 500 ms, etc.), and a second segment (e.g., centered on 942.5 ms and including audio from time 5 ms to 1880 ms) of the audio data may be provided as input to the Audio2Emotion AI model.

In some embodiments, the amount to advance a sliding window is determined based on a desired output frames per second (FPS). For example, if the target output FPS is 30FPS, a sliding window may advance 33 ms (1000 ms/30FPS ˜=33 ms) after each inference is performed.

The Audio2Face AI model may be configured with a different window size than that of Audio2Emotion. For example, Audio2Face may be configured with a window size of 520 ms. So, given the same audio stream of 2000 ms, the Audio2Face AI model may receive a 520 ms segment of the audio stream as an input. The first segment may be from time Oms to 520 ms. The sliding window for the Audio2Face AI model may then advance by a predetermined amount (e.g., 1 ms, 5 ms, 30 ms, 100 ms, 500 ms, etc.), and a second segment of the audio data may be provided as input to the Audio2Face AI model (e.g., from time 30 ms to 550 ms). In some embodiments, the Audio2Emotion sliding window advances at a different rate than the Audio2Face sliding window.

The output data from the Audio2Emotion AI model may be stored in a data structure that can be accessed by the Audio2Face AI model. The output data may include a timestamp and the generated emotion data. The timestamp may correspond to the audio data stream and may represent a start of the sliding window, a midpoint of the sliding window, an end of the sliding window, or the like. For example, the emotion data that was generated using the audio segment from Oms to 1875 ms of the audio stream may have a corresponding timestamp of Oms, 937.5 ms, or 1875 ms.

The Audio2Face AI model may receive a segment of the audio stream and emotion data corresponding to the segment as inputs. For example, the sliding window may grab a segment of the audio stream at a certain position. The data structure storing the generated emotion data corresponding to the audio stream can be queried to determine if there is generated emotion data corresponding to the audio stream segment. If there is emotion data, it can be provided as an input to the Audio2Face AI model. If there is no emotion data, emotion data from a previous audio segment can be used as an input. If no emotion data has been used previously, a predetermined initial emotion data can be used as an input.

In some embodiments, multiple audio streams can be processed simultaneously. For example, a segment of a first audio stream and a segment of a second audio stream can be provided as inputs to Audio2Emotion simultaneously, and Audio2Emotion can perform a batch operation to generate emotion data for the two audio stream segments simultaneously. The generated emotion data may be stored in separate data structures, such as one data structure for each audio stream. Similarly, a segment of the first audio stream with its corresponding emotion data from the data structure corresponding to the first audio stream and a segment of the second audio stream with its corresponding emotion data from the data structure corresponding to the second audio stream can be provided as inputs to Audio2Face simultaneously. Audio2Face can perform a batch operation to generate face animation data for the two audio stream segments simultaneously.

In some embodiments, a padding technique can be used with the sliding window to enable continuous operation of the audio inference system. For example, the AI models may generate optimal results for a particular timestamp of the audio stream when the audio data for that timestamp is centered within the range of input data provided to the AI model. Padding may be necessary to fill the sliding window and ensure that the audio data is appropriately centered within the sliding window, especially at the beginning or end of an audio stream or during transitional processing states.

For example, at the initiation of audio processing, the first sliding window (e.g., inference window) may be centered at timestamp t=0.0 seconds, creating a window that spans from t=−260 ms to t=260 ms for a first AI model with a window size of 520 ms (e.g., Audio2Face). The negative timestamp portion may be filled with silence padding data since no audio data exists prior to the start of the audio stream. Thus, inference can be performed using the AI model as soon as audio data for half of the sliding window is available. For example, with Audio2Face processing using a 520 ms sliding/inference window, inference can begin after 260 ms of audio data has been received instead of waiting for the complete sliding window to fill with audio data. This can substantially reduce system latency by enabling inference operations to begin with the minimum required amount of audio data.

In some embodiments, at the initiation of audio processing, when the received audio data exceeds half of the Audio2Face inference window (e.g., more than 260 ms) but is less than half the Audio2Emotion inference window (e.g., less than 937.5 ms), temporary padding can be added. In such a scenario, the system may have sufficient data to perform Audio2Face inferencing but may require additional padding for the Audio2Emotion processing. For example, if 500 ms of audio data has been received, the audio segment provided to the Audio2Emotion AI model can include 937.5 ms of silence at the beginning, followed by the 500 ms of actual audio data, and the 437.5 ms of trailing silence padding to fill the 1875 ms window. The temporary trailing silence padding can be applied to the audio input for Audio2Emotion and not to the audio input for Audio2Face since Audio2Face has sufficient audio data due to its smaller window size. As additional audio data is received, the amount of trailing silence padding can be reduced, and the silence padding can be replaced with the newly received audio data. Thus, each inference operation can be performed using the maximum available audio data within their respective inference windows.

At the end of the audio stream, the final inference can be centered at the timestamp corresponding to the end of the audio data. For example, for an audio clip of length 10100 ms, the final inference window (e.g., for the Audio2Emotion AI model) may span from t=9162.5 ms to t=11037.5 ms. The portion of the window extending beyond the actual audio duration (e.g., from t=10100 ms to t=11037.5 ms) may be filled with trailing silence padding to maintain the required window dimensions, ensuring complete processing of the audio stream through its entirety.

In some embodiments, one or more preprocessing operations can be performed on the audio stream, or a segment thereof, before providing the audio as input to the Audio2Emotion or Audio2Face AI models. The one or more preprocessing operations can include resampling, rechunking, converting, and/or the like. Resampling can include modifying an audio sample rate of the audio stream to match a target sample rate for the AI model. For example, an input audio stream may have a sample rate of 16 kHz, and an AI model may expect an input audio with 44.1 kHz. The input audio stream can be resampled using a resampling algorithm, such as linear interpolation, Sinc interpolation, etc., from the input sample rate to the target sample rate.

Rechunking can include dividing the input audio stream into segments appropriate for each AI model. For example, the rechunking preprocessing operation can divide the input audio stream into a segment that matches the input requirements of a target AI model (e.g., an Audio2Emotion AI model, an Audio2Face AI model, etc.). The Audio2Emotion AI model may require a larger window size than the Audio2Face AI model, and the rechunking preprocessing operations for each AI model may be configured accordingly. For example, a first rechunking preprocessing operation may generate a first segment of an input audio stream for the Audio2Emotion AI model, and a second rechunking preprocessing operation may generate a smaller segment of the same input audio stream for the Audio2Face AI model. The next segment of the input audio stream (e.g., for the Audio2Emotion AI model, for the Audio2Face AI model) can be generated by another rechunking preprocessing operation, which may be configured with an amount of overlap between consecutive windows and/or a particular windowing function (e.g., Hamming, Hann, etc.).

Converting can include transforming a data type of the input audio stream to a target data type for each AI model. In some embodiments, converting can also include gain control and/or normalization operations. For example, an input audio stream (or a segment of the input audio stream) may be converted from an initial data type to 32-bit floating-point values normalized to the range −1.0 to 1.0.

The advantages of the disclosed techniques include but are not limited to reduced latency when generating face animation data with emotion detection.

The systems and methods described herein may be used for a variety of purposes, by way of example and without limitation, these purposes may include systems or applications for machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine, unautomated vehicles that are manually operated), systems implemented using a robot, aerial systems, medical systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data and/or map data may be used to identify regions of interest (e.g., parking spaces) and sub-regions of interest (e.g., sub-regions of a parking space that includes a curb, wheel stop, etc.) within the simulation environment, and may use this information to perform operations (e.g., parking) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. The synthetic training data (in addition to or alternatively from real-world data) may then be processed to determine geometry and/or other information related to regions of interest, such as parking spaces or pallet delivery locations within a warehouse, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications

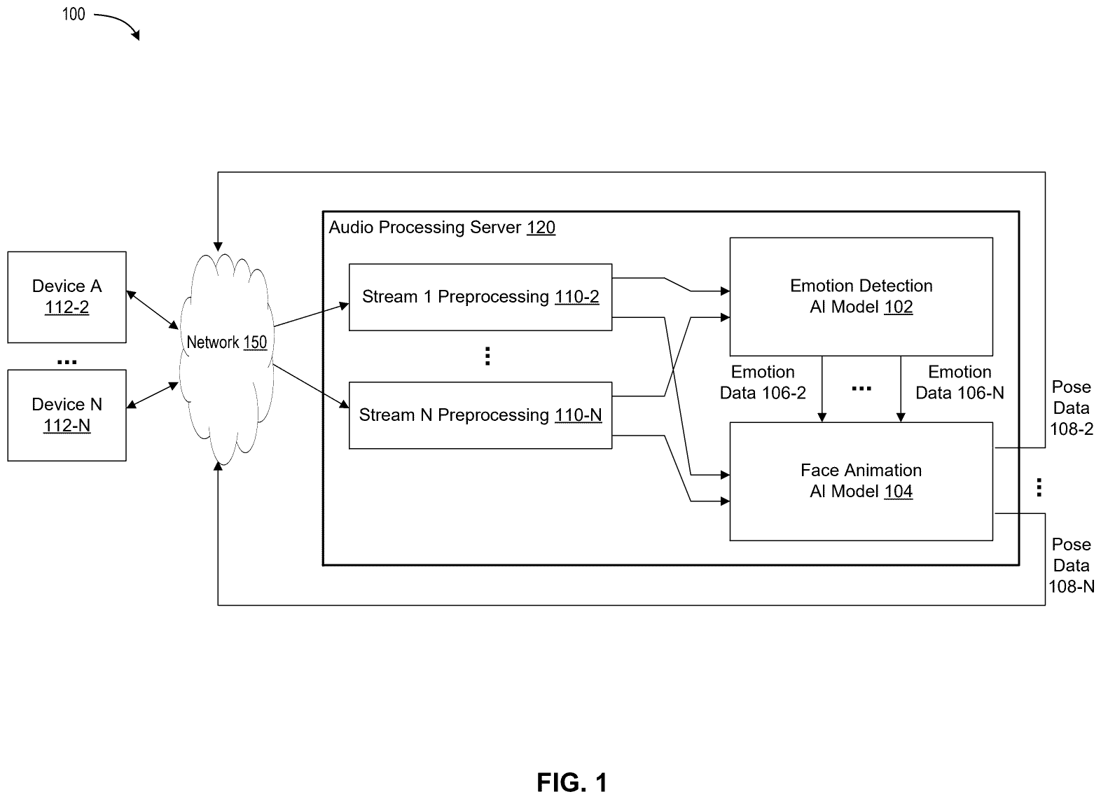

FIG. 1 illustrates an example system architecture 100 for low-latency audio-to-face animation with emotion detection, according to at least one embodiment. In some embodiments, system 100 may include multiple devices (e.g., device A 112-2, . . . , device N 112-N) connected to an audio processing server 120 via a network 150. Network 150 may be a public network (e.g., the Internet), a private network (e.g., a local area network (LAN), or a wide area network (WAN)), a wireless network, a personal area network (PAN), and/or a combination thereof.

Audio processing server 120 may include multiple stream preprocessing components (e.g., stream 1 preprocessing 110-2, . . . , stream N preprocessing 110-N) that prepare incoming audio streams for processing. The preprocessed audio streams may be fed into emotion detection artificial intelligence (AI) model 102 (sometimes referred to as a first AI model), which can analyze the audio to detect emotional content. Emotion detection AI model 102 may produce emotion data (e.g., emotion data 106-2, . . . , emotion data 106-N) for each corresponding audio stream. This emotion data, along with the preprocessed audio streams, may then be provided to face animation AI model 104 (sometimes referred to as a second AI model), which can generate corresponding pose data (108-2, 108-N) for each stream. The pose data may then be transmitted back to the devices (e.g., device A 112-2, device N 112-N) for rendering facial animations that are synchronized with the audio and convey appropriate emotional expressions.

The system 100 can enable multiple audio streams to be processed simultaneously, with each stream maintaining its own independent sequence of emotion detection and facial animation generation. This parallel processing architecture may support real-time or near-real-time (e.g., without transmission delays and/or with negligible (e.g., milliseconds or microseconds) latency) emotional facial animation while maintaining synchronization between detected emotions and facial movements, even when processing multiple audio streams across multiple client devices concurrently.

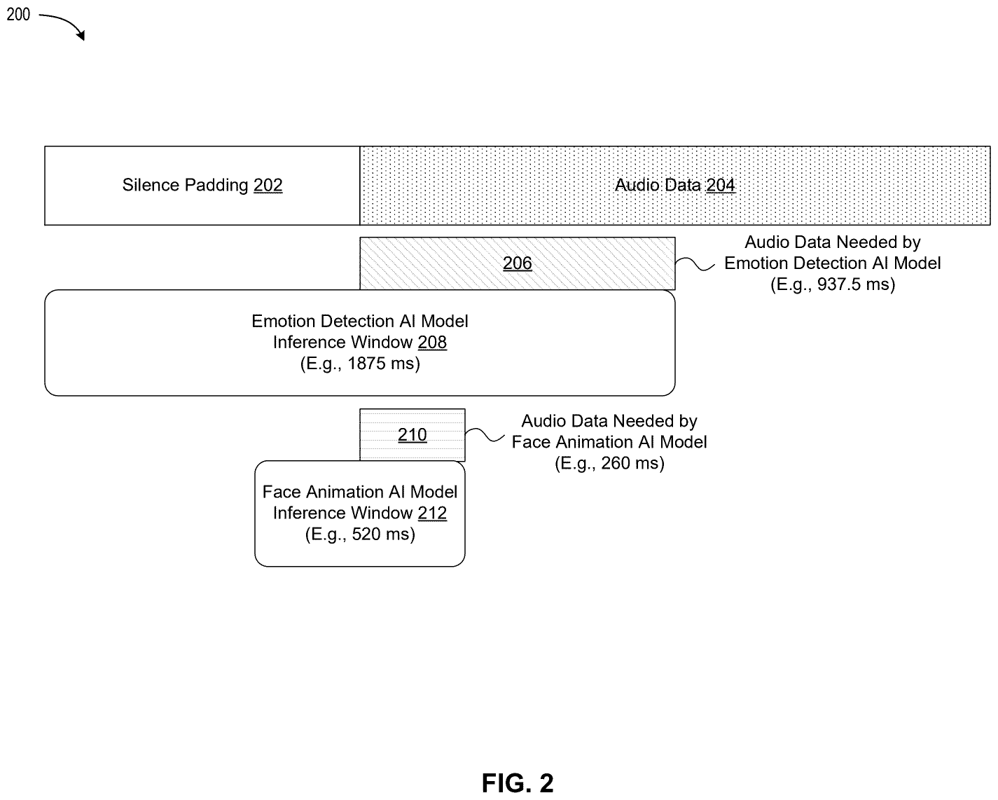

FIG. 2 illustrates an example of audio data windows and inference processing 200 for emotion detection and face animation AI models, according to at least one embodiment. The diagram shows the temporal relationship between different audio processing windows as may be needed by the AI models.

Audio data 204 is shown with silence padding 202 to ensure proper positioning within the inference windows. Portion 206 represents audio data that may be needed by emotion detection AI model, which may span approximately 937.5 milliseconds of the total audio sample. Emotion detection AI model inference window 208 shows the processing window that may be required for emotion analysis, which may span approximately 1875 milliseconds.

Audio data needed by face animation AI model 210 indicates the portion of audio data (approximately 260 milliseconds) that may be required for effective facial animation processing. Face animation AI model inference window 212 shows the processing window for facial animation generation, spanning approximately 520 milliseconds.

The different window sizes reflect the distinct temporal requirements of each AI model. The emotion detection model may require a larger context window to accurately identify emotional patterns in speech, while the face animation model can operate with a smaller window to maintain low-latency response for facial movements. This architecture may enable efficient processing while maintaining synchronization between detected emotions and facial animations.

For optimal inference accuracy, the audio sample may be centered within the inference window. At stream boundaries (initiation and termination), silence padding may be applied bilaterally to maintain the required window dimensions. For real-time processing, the following initialization delays may be implemented. The emotion detection AI model may require 937.5 milliseconds of incoming audio data (total window of 1875 milliseconds, comprising 937.5 milliseconds of silence padding plus 937.5 milliseconds of actual audio). The face animation AI model may need 260 milliseconds of incoming audio data (total window of 520 milliseconds comprising 260 milliseconds of silence padding plus 260 milliseconds of actual audio). Consequently, the face animation AI model can initiate inference and commence output streaming after a 260 millisecond delay, whereas the emotion detection AI model may require approximately 937.5 milliseconds before initial inference is possible. Given the sequential dependency where face animation AI model requires emotion data from emotion detection AI model, the effective latency for the face animation AI model pipeline is increased by 677.5 milliseconds (937.5 milliseconds-260 milliseconds).

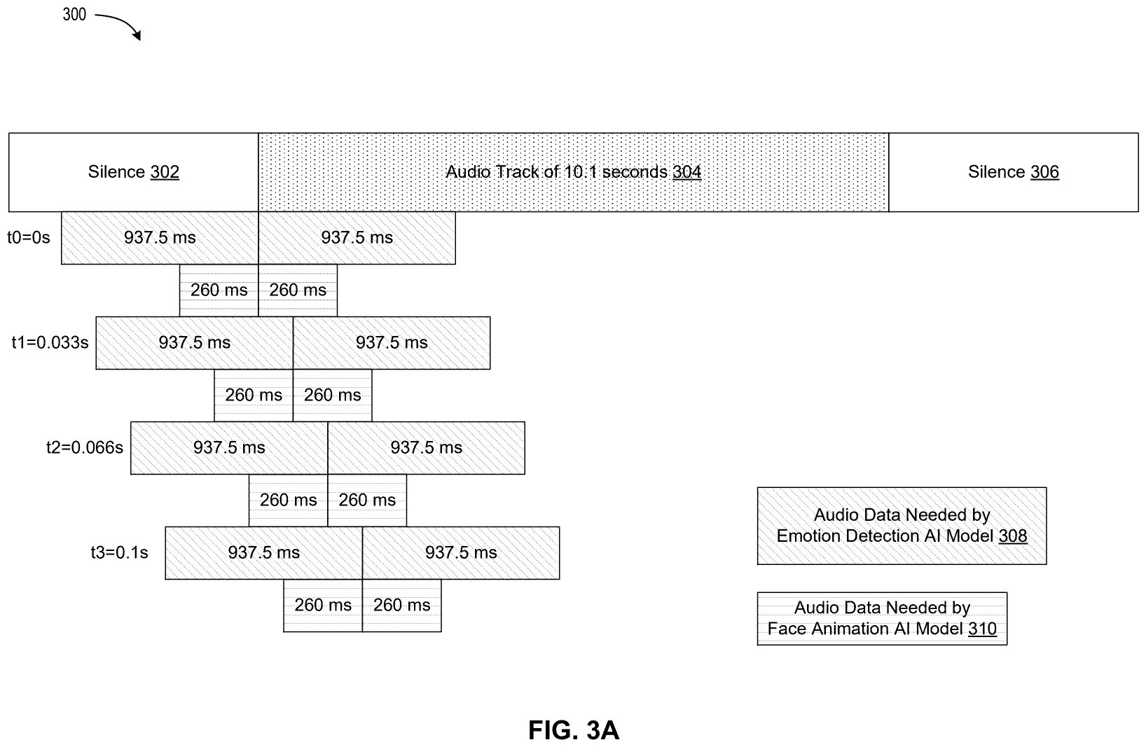

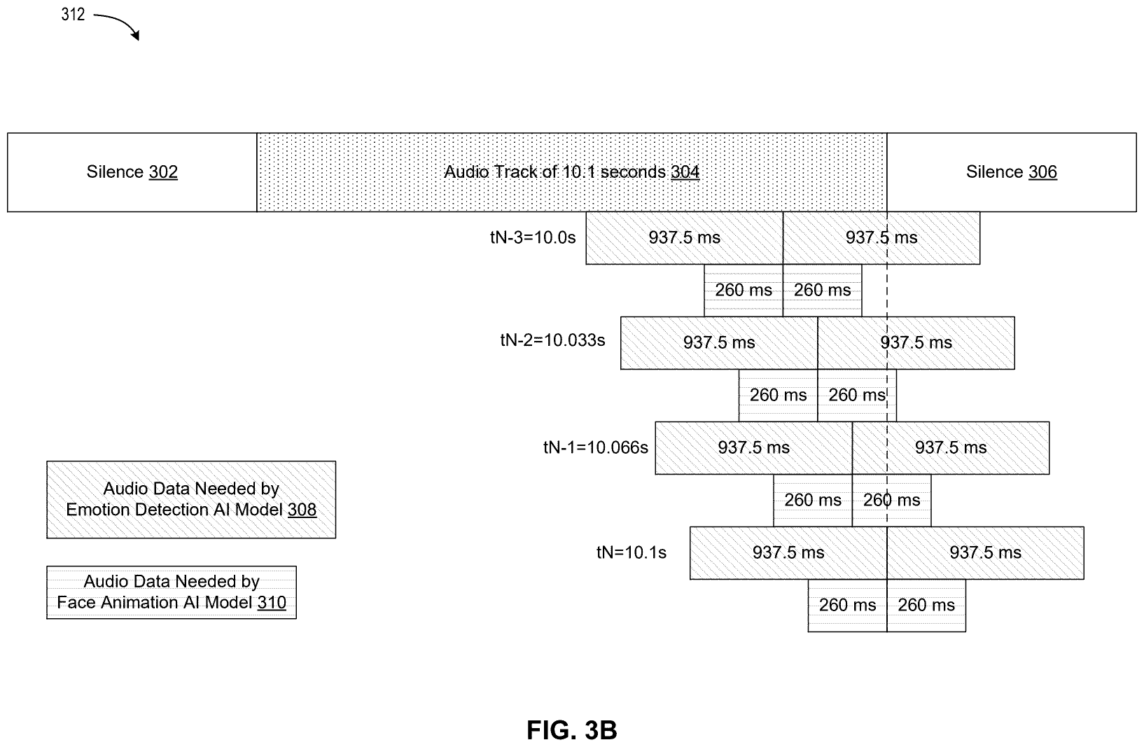

FIG. 3A illustrates a timing diagram 300 showing the processing of multiple audio segments at the beginning of an audio clip, according to at least one embodiment. The diagram depicts a sequential progression of audio processing windows at different points in time (t0=0s, t1=0.033-s, t2=0.066-s, t3=0.1-s).

An audio track 304 of 10.1 seconds is shown between silence periods 302 and 306. For each time position, overlapping segments of 937.5 milliseconds may be processed for emotion detection, while smaller 260 millisecond segments may be processed for face animation. The diagram illustrates how, at the beginning of audio processing, the emotion detection AI model's processing windows (represented by the 937.5 milliseconds segments) and the face animation AI model's processing windows (represented by the 260 milliseconds segments) can advance through the audio stream with partial overlap.

Portion 308 indicates audio data needed by emotion detection AI model, and portion 310 shows audio data needed by face animation AI model. This staggered processing approach may enable continuous analysis of the audio stream while maintaining temporal alignment between emotion detection and facial animation outputs.

FIG. 3B illustrates a timing diagram 312 showing the processing of multiple audio segments at the end of an audio clip, according to at least one embodiment. Similar to FIG. 3A, this diagram shows the sequential progression of processing windows but focusing on the final seconds of the audio track (tN-3=10.0-s, tN-2=10.033-s, tN-1=10.066-s, tN=10.1-s).

As the processing reaches the end of the audio track 304, silence padding 306 may be used to maintain consistent window sizes for both the emotion detection AI model and face animation AI model. The processing windows can continue to advance at regular intervals, with each window capturing a portion of the actual audio data plus the necessary silence padding to complete the required inference window size.

This approach may ensure consistent processing throughout the entire audio stream, from beginning to end, maintaining temporal alignment between the emotion detection and facial animation components even when processing the final segments of audio data.

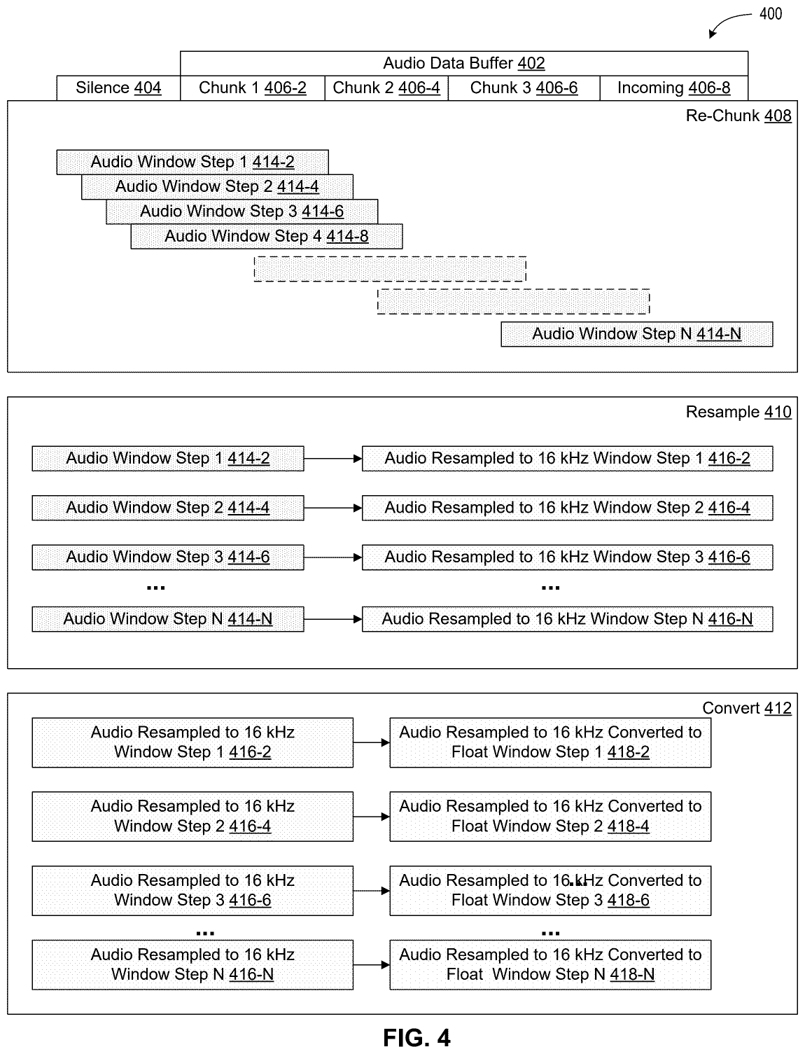

FIG. 4 illustrates a processing pipeline 400 for audio data preprocessing including re-chunking, resampling, and converting operations, according to at least one embodiment. The diagram shows the sequential processing stages applied to incoming audio data to prepare it for inference by the AI models.

An audio data buffer 402 may contain multiple chunks of audio data, including chunk 1 406-2, chunk 2 406-4, chunk 3 406-6, and incoming 406-8, preceded by a padding silence 404. The re-chunk operation 408 can process this buffer to create multiple audio window steps (414-2, 414-4, 414-6, 414-8, 414-N), each of which may represent a time-shifted segment of the audio stream. These audio window steps may then be processed by the resample operation 410, which can convert each window to a standardized sample rate (e.g., 16 kHz, 44.1 kHz) required by the AI models, producing audio resampled windows (416-2, 416-4, 416-6, 416-N). Subsequently, the convert operation 412 may transform the resampled audio data into the appropriate format for AI processing, typically converting short integers to floating-point representation, producing audio resampled to 16 kHz converted to float window steps (418-2, 418-4, 418-6, 418-N).

This re-chunk, resample, and convert process may be implemented in a plugin, which may utilize a buffer management system using a First-In-First-Out (FIFO) queue. As the plugin receives audio data of arbitrary size, the plugin may maintain this queue where incoming audio frames may be sequentially appended. The plugin may employ a timed moving window mechanism, advancing by discarding configurable time increments (e.g., 1/30 to 1/60 second) before forming the next window. This can help ensure temporal resolution across an entire audio stream.

This preprocessing pipeline can help ensure that regardless of the original audio format or sampling rate, the data provided to the AI models is consistently formatted to their requirements, enabling reliable inference performance across variable input conditions.

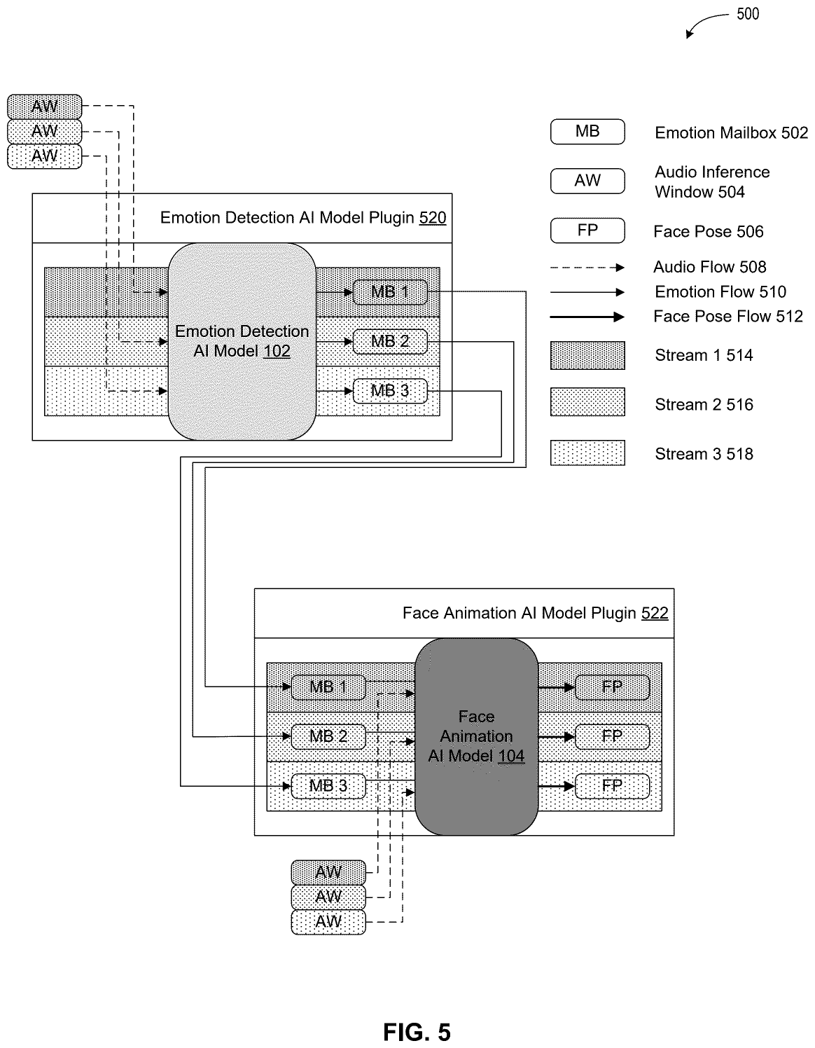

FIG. 5 illustrates a system architecture 500 for emotion flow between audio-to-emotion and audio-to-face AI models using emotion mailboxes, according to at least one embodiment. The diagram depicts the data flow architecture that may enable parallel processing of multiple audio streams while maintaining proper association between detected emotions and facial animations.

The system may include an emotion detection AI model plugin 520 and a face animation AI model plugin 522. Audio inference windows (AW) from multiple streams (stream 1 514, stream 2 516, stream 3 518) can be fed into the emotion detection AI model 102, which processes them to produce emotion data stored in emotion mailboxes (MB 1, MB 2, MB 3).

The emotion mailboxes may be a data structure that manages per-client emotion data storage and synchronization. The emotion mailboxes may facilitate delayed emotion application through a timestamp-based queueing system. Some implementations may include a sender component that may handle insertion of emotion with timecode objects (e.g., emotion map <string, float> storing emotion values and a timestamp uint64_t type for temporal alignment) into a mailbox queue and a receiver component that may manage retrieval of the emotion with timecode objects based on timestamp requirements. The mailbox may utilize a min-heap priority queue sorted by timestamp, which can help ensure O(log n) retrieval of temporally-nearest emotion data.

In some embodiments, these emotion mailboxes serve as storage for the emotion data before it is used for facial animation inference. The face animation AI model 104 may retrieve the emotion data from the appropriate mailbox along with corresponding audio data to generate face poses (FP) for each stream. The diagram shows distinct audio flow 508, emotion flow 510, and face pose flow 512 paths, illustrating how data may move through the system.

This architecture can enable asynchronous processing between emotion detection and facial animation, allowing the system to maintain low latency for facial animations while still incorporating emotion data as it becomes available.

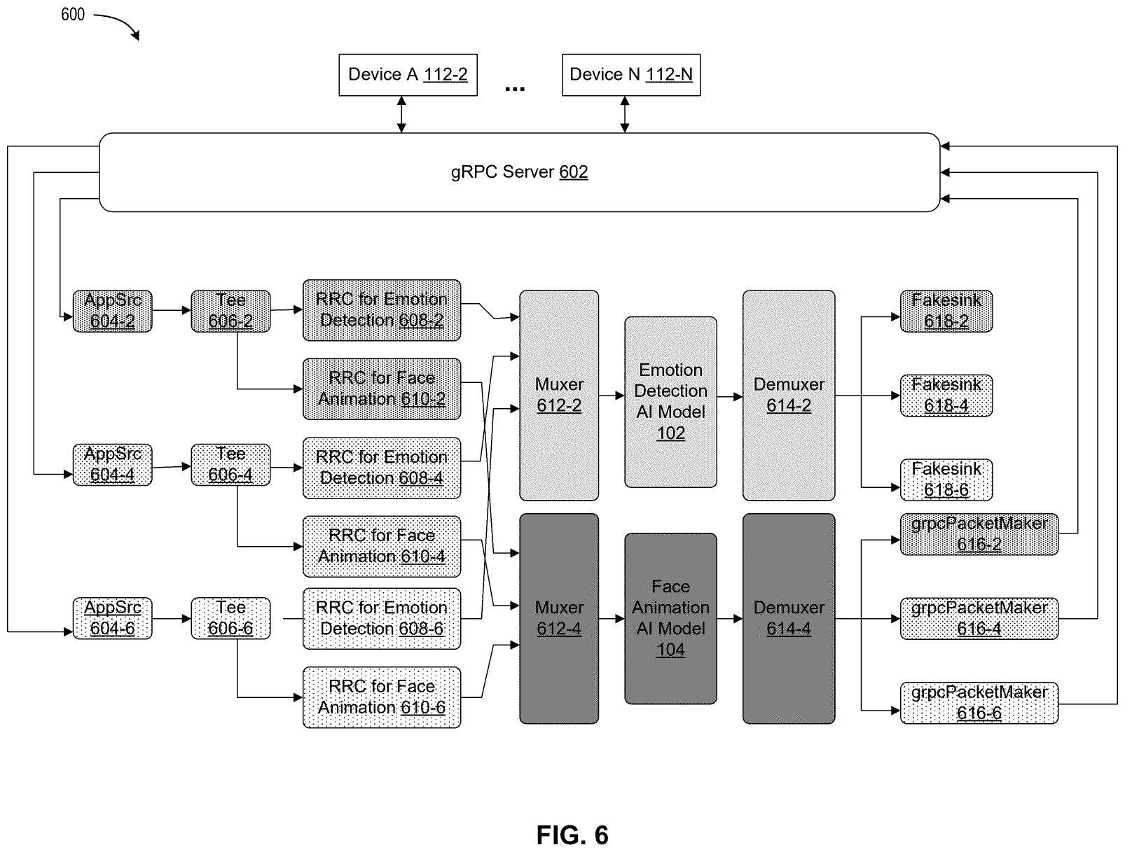

FIG. 6 illustrates an example implementation 600 of a scalable pipeline architecture for processing multiple audio streams concurrently, according to at least one embodiment. The diagram shows a detailed implementation using a gRPC (Google remote procedure call) server 602 to handle multiple device connections (device A 112-2, device N 112-N).

For each connected device, the pipeline may include AppSrc components (604-2, 604-4, 604-6) that receive incoming audio streams. These streams can be split using tee components (606-2, 606-4, 606-6) to create parallel processing paths for both emotion detection and face animation. Each path may include specialized RRC (resample, rechunk, convert) components for emotion detection (608-2, 608-4, 608-6) and for face animation (610-2, 610-4, 610-6).

The RRC components represent an architecture based on decentralized data preprocessing, which is distinct from traditional centralized buffering systems. This architecture can help eliminate common threading issues and can simplify the overall system architecture. Each RRC plugin may be configured specifically for either emotion detection or face animation, with parameters tailored to the requirements of each model.

In some embodiments, the processed audio streams are combined through muxer components (612-2, 612-4) before being sent to the emotion detection AI model 102 and face animation AI model 104 components. After inference, the results may be separated by demuxer components (614-2, 614-4) and directed to appropriate output components (fakesink 618-2, 618-4, 618-6 for emotion data and grpcPacketMaker 616-2, 616-4, 616-6 for face animation data).

This implementation can enable efficient batch processing of multiple audio streams while maintaining proper data flow and association between streams, emotions, and facial animations.

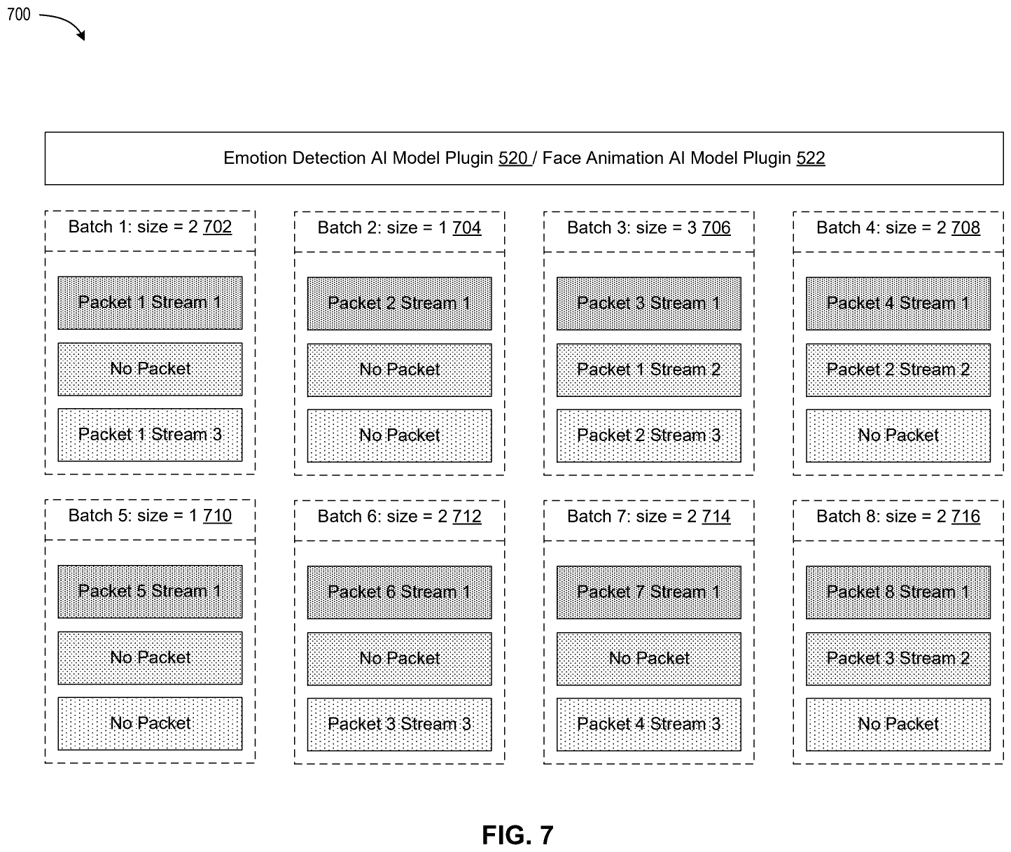

FIG. 7 illustrates an example of batch inference 700 for processing multiple audio streams simultaneously through emotion detection and face animation AI models, according to at least one embodiment. The diagram shows how audio packets from different streams may be grouped into processing batches to maximize computational efficiency.

The emotion detection AI model plugin 520 and face animation AI model plugin 522 can process batches of audio packets from multiple streams concurrently. Each batch (batch 1 702 through batch 8 716) may contain a different combination of packets from various streams. For example, batch 1 702 can contain packet 1 from stream 1 and packet 1 from stream 3, while batch 3 706 may contain packet 3 from stream 1, packet 1 from stream 2, and packet 2 from stream 3.

Each batch may include between 1 and N audio inference windows. The inference engine processing may process each batch at a time to maximize computational efficiency. The size of a specific batch may be determined by a multiplexer plugin that determines how much to wait from individual streams of packets before creating a new batch. This batching approach can improve computational efficiency compared to processing each input individually. This batching approach may allow the system to maximize GPU (graphics processing unit) utilization by processing multiple audio streams in parallel, rather than sequentially. Empty slots in each batch (indicated as “no packet”) show how the system can flexibly handle varying rates of incoming audio data across different streams.

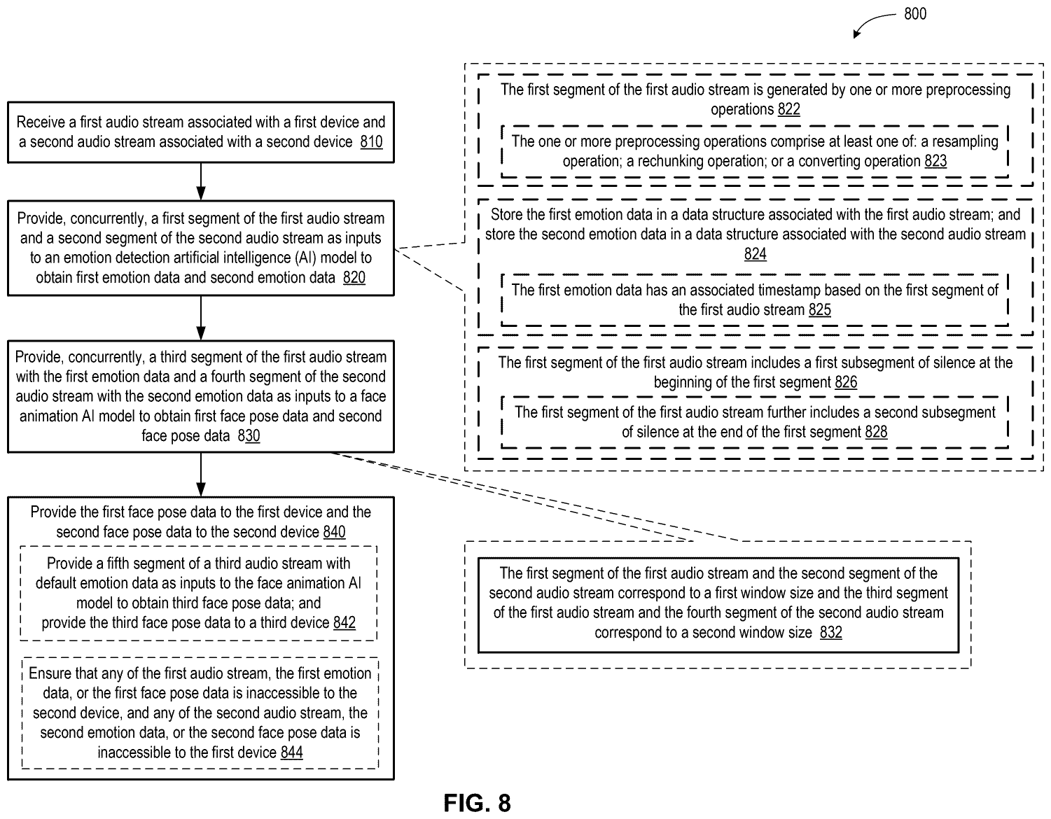

FIG. 8 is a flow diagram of a method 800 for low-latency audio-to-face animation with emotion detection across multiple devices, according to at least one embodiment. Method 800 can be performed using one or more processing units (e.g., CPUs, GPUs, accelerators, physics processing units (PPUs), data processing units (DPUs), etc.), which may include (or communicate with) one or more memory devices. In at least one embodiment, method 800 can be performed using a processing device or processing devices. In at least one embodiment, method 800 can be performed using processing units of a cloud function controller. In at least one embodiment, method 800 can be performed by the audio processing server 120 of FIG. 1. In at least one embodiment, processing units performing method 800 can be executing instructions stored on a non-transient computer readable storage media. In at least one embodiment, method 800 can be performed using multiple processing threads (e.g., CPU threads and/or GPU threads), individual threads executing one or more individual functions, routines, subroutines, or operations of the method. In at least one embodiment, processing threads implementing method 800 can be synchronized (e.g., using semaphores, critical sections, and/or other thread synchronization mechanisms). Alternatively, processing threads implementing method 800 can be executed asynchronously with respect to each other. Various operations of method 800 can be performed in a different order compared with the order shown in FIG. 8. Some operations of the method 800 can be performed concurrently with other operations. In at least one embodiment, one or more operations shown in FIG. 8 may not always be performed.

The method may begin at block 810 with the audio processing server 120 of FIG. 1 receiving a first audio stream associated with device A 112-2 and a second audio stream associated with device N 112-N through network 150. For example, device A 112-2 might be a smartphone capturing a voice saying “Hello, how are you today?” with a happy tone, while device N 112-N could be another laptop capturing a voice saying “I'm feeling a bit frustrated” with an annoyed tone, both being transmitted to the audio processing server 120 as shown in FIG. 1.

Referring to FIG. 8, at block 820, the method may continue with the emotion detection AI model plugin 520 of FIG. 5 providing, concurrently, a first segment of the first audio stream and a second segment of the second audio stream as inputs to the emotion detection AI model 102 to obtain first emotion data 106-2 and second emotion data 106-N. As illustrated in FIG. 7, this concurrent processing can occur through batch inference 700, where multiple audio packets from different streams (e.g., batch 1 702 containing packet 1 from stream 1 and packet 1 from stream 3) can be processed simultaneously by the emotion detection AI model plugin 520.

In some embodiments, the first segment of the first audio stream may be generated by the RRC (resample, rechunk, convert) components 608-2, 608-4, 608-6 for emotion detection shown in FIG. 6, which perform preprocessing operations 822. For example, as shown in FIG. 4, these preprocessing operations can comprise at least one of: a resampling operation 410 that converts an audio sample rate from 16 kHz to 44.1 kHz, a rechunking operation 408 that divides the audio into appropriate 1875 ms windows as illustrated in FIG. 2, or a converting operation 412 that transforms the audio data from short integers to floating-point representation.

The emotion data may be stored in emotion mailboxes (MB 1, MB 2, MB 3) shown in FIG. 5, which may function as data structures associated with each audio stream 824. For instance, the emotion data detected from “Hello, how are you today?” might be stored with values indicating happiness (e.g., {happiness: 0.85, anger: 0.02, sadness: 0.01}), while the second audio may generate emotion data indicating frustration.

As shown in FIG. 5, the emotion data can have an associated timestamp based on the audio segment 825. For example, the emotion data generated from the first 1875 ms window of audio might have a timestamp of 937.5 ms (the center of the window), allowing it to be properly synchronized with the corresponding facial animation.

As illustrated in FIG. 3A, the audio segments may include silence padding 202 at the beginning 826 of each segment, particularly when processing the start of an audio stream where no prior audio exists. For example, at t0=0 s, the 937.5 ms emotion detection window needs silence padding before the actual audio data begins.

Similarly, as shown in FIG. 3B, when processing the end of an audio clip, the audio segments may include silence padding 306 at the end 828 of each segment. For instance, at tN=10.1 s, the 937.5 ms emotion detection window may extend beyond the actual audio data, requiring silence padding to complete the required window size.

Referring to FIG. 8, at block 830, the method may provide, concurrently, a third segment of the first audio stream with the first emotion data and a fourth segment of the second audio stream with the second emotion data as inputs to the face animation AI model 104 through the face animation AI model plugin 522 shown in FIG. 5, to obtain first face pose data 108-2 and second face pose data 108-N. As depicted in FIG. 7, this concurrent processing may happen through batch inference, where multiple packets from different streams may be processed simultaneously (e.g., batch 2 704 containing packet 2 from stream 1 and packet 1 from stream 2).

As illustrated in FIG. 2, the segments may correspond to different window sizes 832, with emotion detection typically requiring larger windows (1875 ms) than face animation (520 ms). For example, while the emotion detection AI model 102 needs a 1875 ms window to accurately detect emotions like happiness or frustration, the face animation AI model 104 can operate with a smaller 520 ms window to maintain low-latency response for facial movements such as lip synchronization.

Subsequently, at block 840, the method may provide the first face pose data 108-2 to the first device 112-2 and the second face pose data 108-N to the second device 112-N (e.g., through the grpcPacketMaker components 616-2, 616-4, 616-6 shown in FIG. 6). For example, the first device would receive face pose data that shows a smiling expression with appropriate mouth movements for saying “Hello, how are you today?”, while the second device would receive face pose data showing a frustrated expression with appropriate mouth movements for saying “I'm feeling a bit frustrated.”

Referring to FIG. 8, in some embodiments, as shown in optional block 842, the method can handle a third audio stream with default emotion data when emotion data is not yet available. For instance, as shown in FIG. 5, if a new client connects to the system and begins streaming audio but the emotion detection AI model 102 has not yet generated emotion data (due to its larger 1875 ms window requirement), the face animation AI model 104 can use a default neutral emotion state to generate initial face animations until actual emotion data becomes available, ensuring continuous operation even during system initialization.

Referring to FIG. 8, in some embodiments, as shown in optional block 844, the method can ensure that any of the first audio stream, the first emotion data, or the first face pose data is inaccessible to the second device, and any of the second audio stream, the second emotion data, or the second face pose data is inaccessible to the first device. For instance, the audio processing server 120 can ensure that the audio stream from the device A 112-2, the emotion data 106-2 and the pose-date 108-2 are only accessible to the device A 112-2, and the audio stream from the device N 112-N, the emotion data 106-N and the pose data 108-N are only accessible to the device N 112-N.

### Inference and Training Logic

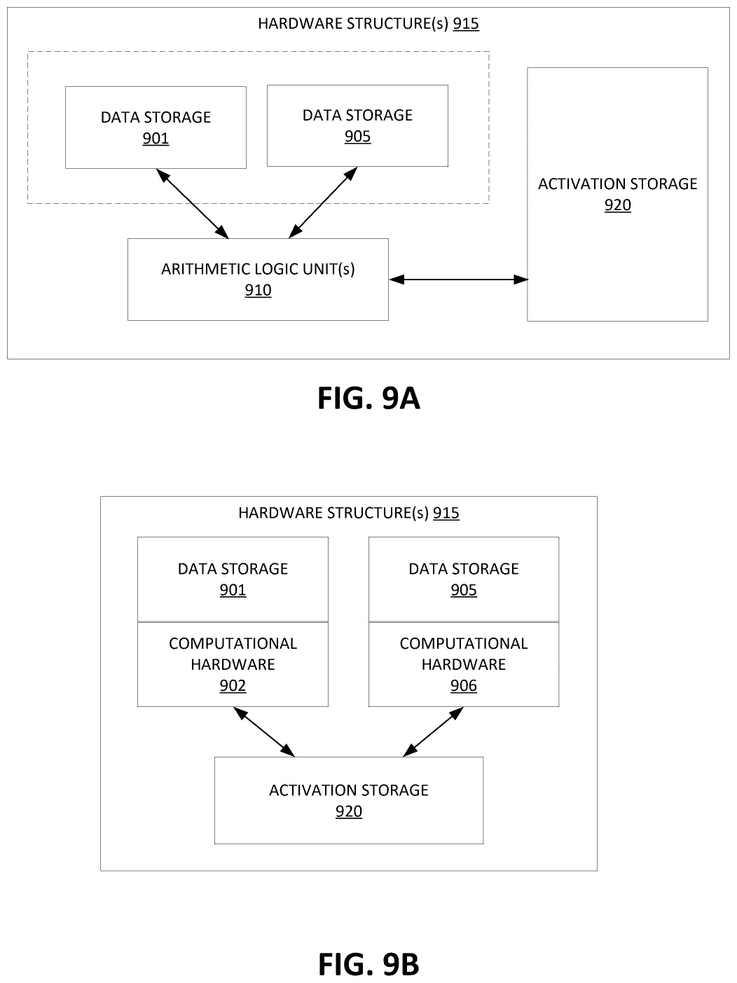

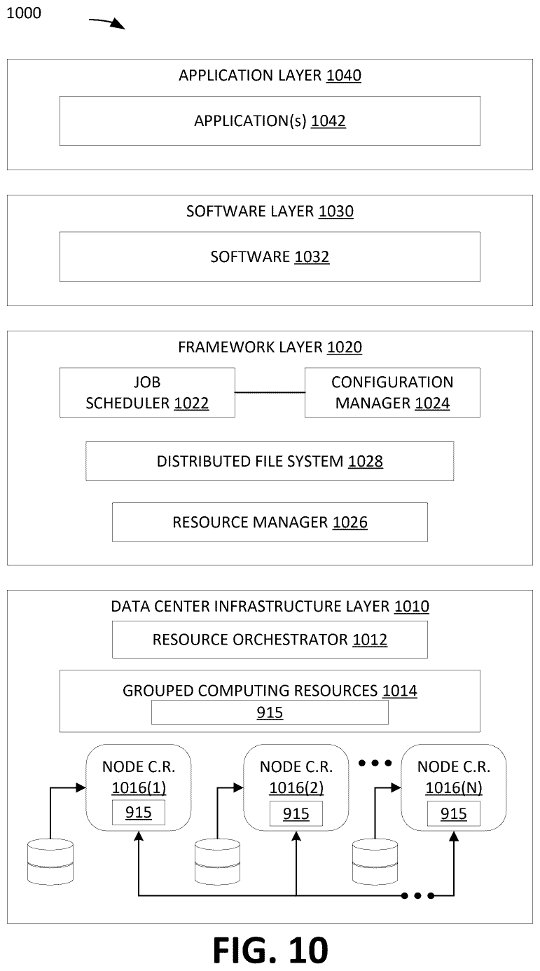

FIG. 9A illustrates inference and/or training logic 915 used to perform inferencing and/or training operations associated with one or more embodiments, such as with regards to an artificial intelligence (AI) model that generates animation data from audio data. Details regarding inference and/or training logic 915 are provided below in conjunction with FIGS. 9A and/or 9B.

In at least one embodiment, inference and/or training logic 915 may include, without limitation, code and/or data storage 901 to store forward and/or output weight and/or input/output data, and/or other parameters to configure neurons or layers of a neural network trained and/or used for inferencing in aspects of one or more embodiments. In at least one embodiment, training logic 915 may include, or be coupled to code and/or data storage 901 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 901 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 901 may be included with other on-chip or off-chip data storage, including a processor's L1, L2, or L3 cache or system memory.

In at least one embodiment, any portion of code and/or data storage 901 may be internal or external to one or more processors or other hardware logic devices or circuits. In at least one embodiment, code and/or code and/or data storage 901 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 901 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 915 may include, without limitation, a code and/or data storage 905 to store backward and/or output weight and/or input/output data corresponding to neurons or layers of a neural network trained and/or used for inferencing in aspects of one or more embodiments. In at least one embodiment, code and/or data storage 905 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 915 may include, or be coupled to code and/or data storage 905 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 905 may be included with other on-chip or off-chip data storage, including a processor's L1, L2, or L3 cache or system memory. In at least one embodiment, any portion of code and/or data storage 905 may be internal or external to on one or more processors or other hardware logic devices or circuits. In at least one embodiment, code and/or data storage 905 may be cache memory, DRAM, SRAM, non-volatile memory (e.g., Flash memory), or other storage. In at least one embodiment, choice of whether code and/or data storage 905 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 901 and code and/or data storage 905 may be separate storage structures. In at least one embodiment, code and/or data storage 901 and code and/or data storage 905 may be same storage structure. In at least one embodiment, code and/or data storage 901 and code and/or data storage 905 may be partially same storage structure and partially separate storage structures. In at least one embodiment, any portion of code and/or data storage 901 and code and/or data storage 905 may be included with other on-chip or off-chip data storage, including a processor's L1, L2, or L3 cache or system memory.

In at least one embodiment, inference and/or training logic 915 may include, without limitation, one or more arithmetic logic unit(s) (“ALU(s)”) 910, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 920 that are functions of input/output and/or weight parameter data stored in code and/or data storage 901 and/or code and/or data storage 905. In at least one embodiment, activations stored in activation storage 920 are generated according to linear algebraic and or matrix-based mathematics performed by ALU(s) 910 in response to performing instructions or other code, wherein weight values stored in code and/or data storage 905 and/or code and/or data storage 901 are used as operands along with other values, such as bias values, gradient information, momentum values, or other parameters or hyperparameters, any or all of which may be stored in code and/or data storage 905 or code and/or data storage 901 or another storage on or off-chip.

In at least one embodiment, ALU(s) 910 are included within one or more processors or other hardware logic devices or circuits, whereas in another embodiment, ALU(s) 910 may be external to a processor or other hardware logic device or circuit that uses them (e.g., a co-processor). In at least one embodiment, ALUs 910 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 901, code and/or data storage 905, and activation storage 920 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 920 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 920 may be cache memory, DRAM, SRAM, non-volatile memory (e.g., Flash memory), or other storage. In at least one embodiment, activation storage 920 may be completely or partially within or external to one or more processors or other logical circuits. In at least one embodiment, choice of whether activation storage 920 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 915 illustrated in FIG. 9A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 9A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 9B illustrates inference and/or training logic 915, according to at least one or more embodiments. In at least one embodiment, inference and/or training logic 915 may include, without limitation, hardware logic in which computational resources are dedicated or otherwise exclusively used in conjunction with weight values or other information corresponding to one or more layers of neurons within a neural network. In at least one embodiment, inference and/or training logic 915 illustrated in FIG. 9B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic 915 includes, without limitation, code and/or data storage 901 and code and/or data storage 905, which may be used to store code (e.g., graph code), weight values and/or other information, including bias values, gradient information, momentum values, and/or other parameter or hyperparameter information. In at least one embodiment illustrated in FIG. 9B, each of code and/or data storage 901 and code and/or data storage 905 is associated with a dedicated computational resource, such as computational hardware 902 and computational hardware 906, respectively. In at least one embodiment, each of computational hardware 902 and computational hardware 906 comprises one or more ALUs that perform mathematical functions, such as linear algebraic functions, only on information stored in code and/or data storage 901 and code and/or data storage 905, respectively, result of which is stored in activation storage 920.

In at least one embodiment, each of code and/or data storage 901 and 905 and corresponding computational hardware 902 and 906, respectively, correspond to different layers of a neural network, such that resulting activation from one “storage/computational pair 901/902” of code and/or data storage 901 and computational hardware 902 is provided as an input to “storage/computational pair 905/906” of code and/or data storage 905 and computational hardware 906, in order to mirror conceptual organization of a neural network. In at least one embodiment, each of storage/computational pairs 901/902 and 905/906 may correspond to more than one neural network layer. In at least one embodiment, additional storage/computation pairs (not shown) subsequent to or in parallel with storage computation pairs 901/902 and 905/906 may be included in inference and/or training logic 915.

### Data Center

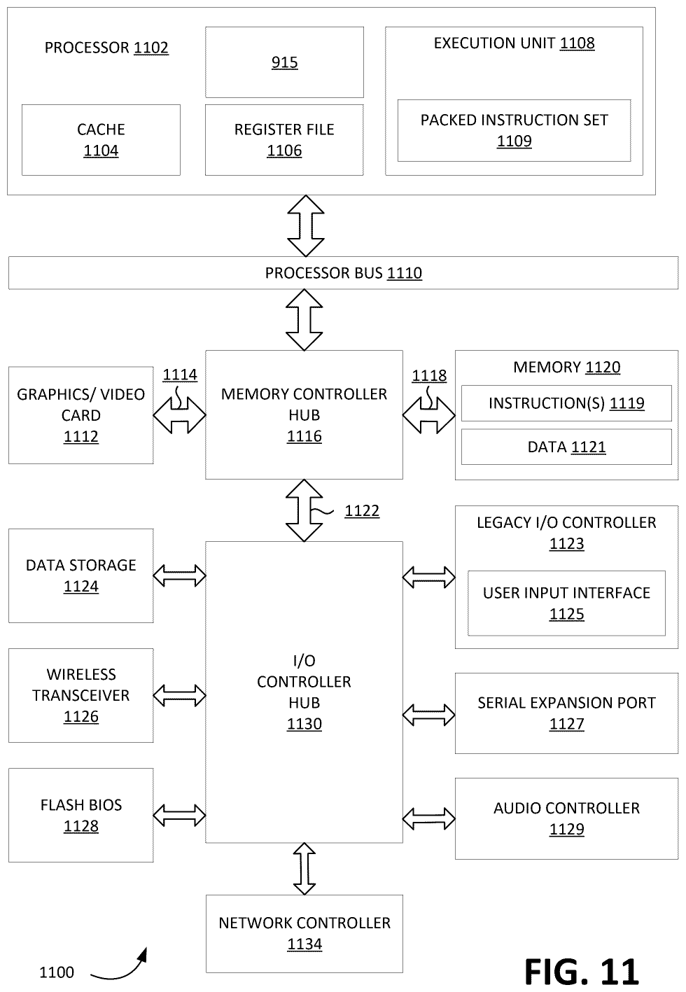

FIG. 10 illustrates an example data center 1000, in which at least one embodiment may be used. For example, the data center 1000 may house the audio processing server 120, and/or the devices 112-2, . . . , 112-N of FIG. 1 in embodiments. In at least one embodiment, data center 1000 includes a data center infrastructure layer 1010, a framework layer 1020, a software layer 1030, and an application layer 1040.

In at least one embodiment, as shown in FIG. 10, data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, grouped computing resources 1014 may include separate groupings of node C.R.s housed within one or more racks (not shown), or many racks housed in data centers at various geographical locations (also not shown). Separate groupings of node C.R.s within grouped computing resources 1014 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1012 may configure or otherwise control one or more node C.R.s 1016(1)-1016(N) and/or grouped computing resources 1014. In at least one embodiment, resource orchestrator 1012 may include a software design infrastructure (“SDI”) management entity for data center 1000. In at least one embodiment, resource orchestrator may include hardware, software or some combination thereof.

In at least one embodiment, as shown in FIG. 10, framework layer 1020 includes a job scheduler 1022, a configuration manager 1024, a resource manager 1026 and a distributed file system 1028. In at least one embodiment, framework layer 1020 may include a framework to support software 1032 of software layer 1030 and/or one or more application(s) 1042 of application layer 1040. In at least one embodiment, software 1032 or application(s) 1042 may respectively include web-based service software or applications, such as those provided by Amazon Web Services, Google Cloud and Microsoft Azure. In at least one embodiment, framework layer 1020 may be, but is not limited to, a type of free and open-source software web application framework such as Apache Spark™ (hereinafter “Spark”) that may utilize distributed file system 1028 for large-scale data processing (e.g., “big data”). In at least one embodiment, job scheduler 1022 may include a Spark driver to facilitate scheduling of workloads supported by various layers of data center 1000. In at least one embodiment, configuration manager 1024 may be capable of configuring different layers such as software layer 1030 and framework layer 1020 including Spark and distributed file system 1028 for supporting large-scale data processing. In at least one embodiment, resource manager 1026 may be capable of managing clustered or grouped computing resources mapped to or allocated for support of distributed file system 1028 and job scheduler 1022. In at least one embodiment, clustered or grouped computing resources may include grouped computing resource 1014 at data center infrastructure layer 1010. In at least one embodiment, resource manager 1026 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1028 of framework layer 1020. The one or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1028 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1024, resource manager 1026, and resource orchestrator 1012 may implement any number and type of self-modifying actions based on any amount and type of data acquired in any technically feasible fashion. In at least one embodiment, self-modifying actions may relieve a data center operator of data center 1000 from making possibly bad configuration decisions and possibly avoiding underutilized and/or poor performing portions of a data center.

In at least one embodiment, data center 1000 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1000. In at least one embodiment, trained machine learning models corresponding to one or more neural networks may be used to infer or predict information using resources described above with respect to data center 1000 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 915 are used to perform inferencing and/or training operations associated with one or more embodiments. Details regarding inference and/or training logic 915 are provided below in conjunction with FIGS. 9A and/or 9B. In at least one embodiment, inference and/or training logic 915 may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

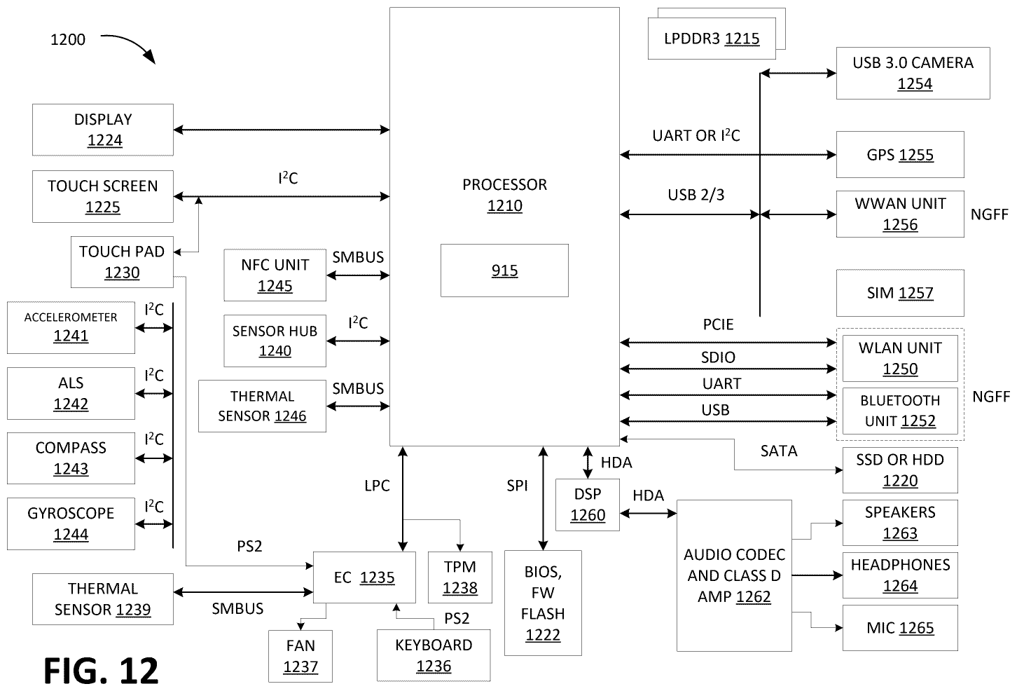

FIG. 11 is a block diagram illustrating an exemplary computer system 1100, which may be a system with interconnected devices and components, a system-on-a-chip (SOC) or some combination thereof 1100 formed with a processor that may include execution units to execute an instruction, according to at least one embodiment. In some embodiments, the computer system 1100 can correspond to the audio processing server 120, and/or the devices 112-2, . . . , 112-N of FIG. 1. In at least one embodiment, computer system 1100 may include, without limitation, a component, such as a processor 1102 to employ execution units including logic to perform algorithms for process data, in accordance with present disclosure, such as in embodiment described herein. For example, processor 1102 can be configured to execute instructions for implementing streaming and playback of synchronized audio and animation data. In at least one embodiment, computer system 1100 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1100 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 1100 may include, without limitation, processor 1102 that may include, without limitation, one or more execution units 1108 to perform machine learning model training and/or inferencing according to techniques described herein. In at least one embodiment, computer system 1100 is a single processor desktop or server system, but in another embodiment computer system 1100 may be a multiprocessor system. In at least one embodiment, processor 1102 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 1102 may be coupled to a processor bus 1110 that may transmit data signals between processor 1102 and other components in computer system 1100.

In at least one embodiment, processor 1102 may include, without limitation, a Level 1 (“L1”) internal cache memory (“cache”) 1104. In at least one embodiment, processor 1102 may have a single internal cache or multiple levels of internal cache. In at least one embodiment, cache memory may reside external to processor 1102. Other embodiments may also include a combination of both internal and external caches depending on particular implementation and needs. In at least one embodiment, register file 1106 may store different types of data in various registers including, without limitation, integer registers, floating point registers, status registers, and instruction pointer register.

In at least one embodiment, execution unit 1108, including, without limitation, logic to perform integer and floating point operations, also resides in processor 1102. In at least one embodiment, processor 1102 may also include a microcode (“ucode”) read only memory (“ROM”) that stores microcode for certain macro instructions. In at least one embodiment, execution unit 1108 may include logic to handle a packed instruction set 1109. In at least one embodiment, by including packed instruction set 1109 in an instruction set of a general-purpose processor 1102, along with associated circuitry to execute instructions, operations used by many multimedia applications may be performed using packed data in a general-purpose processor 1102. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 1108 may also be used in microcontrollers, embedded processors, graphics devices, DSPs, and other types of logic circuits. In at least one embodiment, computer system 1100 may include, without limitation, a memory 1120. In at least one embodiment, memory 1120 may be implemented as a Dynamic Random Access Memory (“DRAM”) device, a Static Random Access Memory (“SRAM”) device, flash memory device, or other memory device. In at least one embodiment, memory 1120 may store instruction(s) 1119 and/or data 1121 represented by data signals that may be executed by processor 1102.

In at least one embodiment, system logic chip may be coupled to processor bus 1110 and memory 1120. In at least one embodiment, system logic chip may include, without limitation, a memory controller hub (“MCH”) 1116, and processor 1102 may communicate with MCH 1116 via processor bus 1110. In at least one embodiment, MCH 1116 may provide a high bandwidth memory path 1118 to memory 1120 for instruction and data storage and for storage of graphics commands, data and textures. In at least one embodiment, MCH 1116 may direct data signals between processor 1102, memory 1120, and other components in computer system 1100 and to bridge data signals between processor bus 1110, memory 1120, and a system I/O 1122. In at least one embodiment, system logic chip may provide a graphics port for coupling to a graphics controller. In at least one embodiment, MCH 1116 may be coupled to memory 1120 through a high bandwidth memory path 1118 and graphics/video card 1112 may be coupled to MCH 1116 through an Accelerated Graphics Port (“AGP”) interconnect 1114.

In at least one embodiment, computer system 1100 may use system I/O 1122 that is a proprietary hub interface bus to couple MCH 1116 to I/O controller hub (“ICH”) 1130. In at least one embodiment, ICH 1130 may provide direct connections to some I/O devices via a local I/O bus. In at least one embodiment, local I/O bus may include, without limitation, a high-speed I/O bus for connecting peripherals to memory 1120, chipset, and processor 1102. Examples may include, without limitation, an audio controller 1129, a firmware hub (“flash BIOS”) 1128, a wireless transceiver 1126, a data storage 1124, a legacy I/O controller 1123 containing user input and keyboard interfaces 1125, a serial expansion port 1127, such as Universal Serial Bus (“USB”), and a network controller 1134, which may include in some embodiments, a data processing unit. Data storage 1124 may comprise a hard disk drive, a floppy disk drive, a CD-ROM device, a flash memory device, or other mass storage device.

In at least one embodiment, FIG. 11 illustrates a system, which includes interconnected hardware devices or “chips”, whereas in other embodiments, FIG. 11 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 1100 are interconnected using compute express link (CXL) interconnects.

Inference and/or training logic 915 are used to perform inferencing and/or training operations associated with one or more embodiments. Details regarding inference and/or training logic 915 are provided below in conjunction with FIGS. 9A and/or 9B. In at least one embodiment, inference and/or training logic 915 may be used in system FIG. 11 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

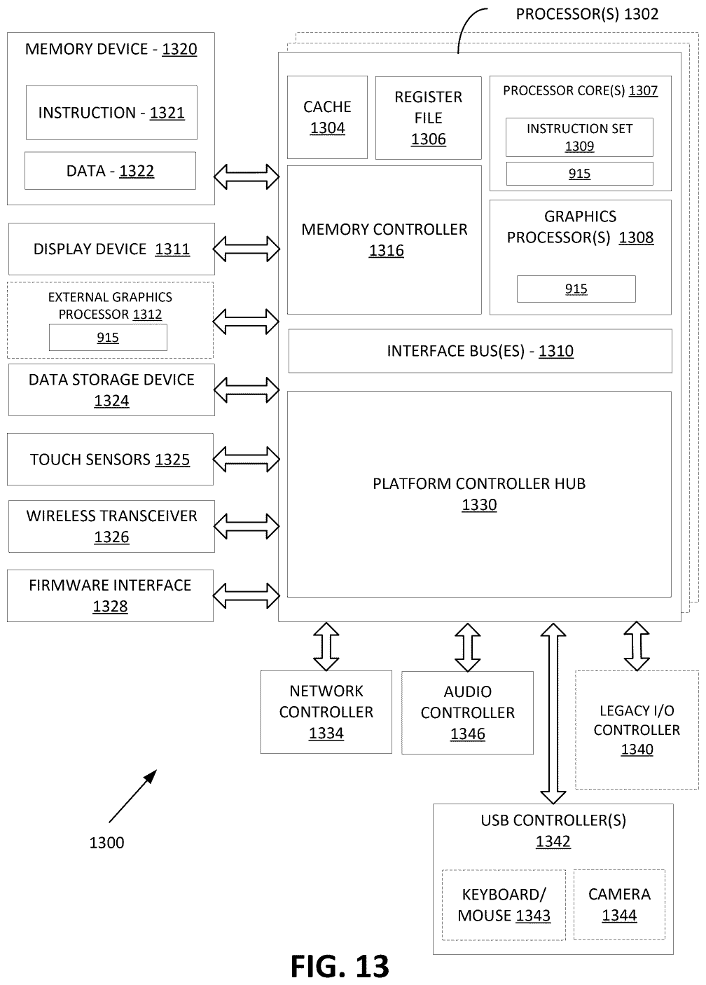

FIG. 12 is a block diagram illustrating an electronic device 1200 for utilizing a processor 1210, according to at least one embodiment. In at least one embodiment, electronic device 1200 may be, for example and without limitation, a notebook, a tower server, a rack server, a blade server, a laptop, a desktop, a tablet, a mobile device, a phone, an embedded computer, an edge device, an IoT device, or any other suitable electronic device. For example, electronic device 1200 can correspond to the audio processing server 120, and/or the devices 112-2, . . . , 112-N of FIG. 1.

In at least one embodiment, system 1200 may include, without limitation, processor 1210 communicatively coupled to any suitable number or kind of components, peripherals, modules, or devices. In at least one embodiment, processor 1210 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 12 illustrates a system, which includes interconnected hardware devices or “chips”, whereas in other embodiments, FIG. 12 may illustrate an exemplary System on a Chip (“SoC”). In at least one embodiment, devices illustrated in FIG. 12 may be interconnected with proprietary interconnects, standardized interconnects (e.g., PCIe) or some combination thereof. In at least one embodiment, one or more components of FIG. 12 are interconnected using compute express link (CXL) interconnects.

In at least one embodiment, FIG. 12 may include a display 1224, a touch screen 1225, a touch pad 1230, a Near Field Communications unit (“NFC”) 1245, a sensor hub 1240, a thermal sensor 1246, an Express Chipset (“EC”) 1235, a Trusted Platform Module (“TPM”) 1238, BIOS/firmware/flash memory (“BIOS, FW Flash”) 1222, a DSP 1260, a drive 1220 such as a Solid State Disk (“SSD”) or a Hard Disk Drive (“HDD”), a wireless local area network unit (“WLAN”) 1250, a Bluetooth unit 1252, a Wireless Wide Area Network unit (“WWAN”) 1256, a Global Positioning System (GPS) 1255, a camera (“USB 3.0 camera”) 1254 such as a USB 3.0 camera, and/or a Low Power Double Data Rate (“LPDDR”) memory unit (“LPDDR3”) 1215 implemented in, for example, LPDDR3 standard. These components may each be implemented in any suitable manner.

In at least one embodiment, other components may be communicatively coupled to processor 1210 through components discussed above. In at least one embodiment, an accelerometer 1241, Ambient Light Sensor (“ALS”) 1242, compass 1243, and a gyroscope 1244 may be communicatively coupled to sensor hub 1240. In at least one embodiment, thermal sensor 1239, a fan 1237, a keyboard 1236, and a touch pad 1230 may be communicatively coupled to EC 1235. In at least one embodiment, speaker 1263, headphones 1264, and microphone (“mic”) 1265 may be communicatively coupled to an audio unit (“audio codec and class d amp”) 1262, which may in turn be communicatively coupled to DSP 1260. In at least one embodiment, audio unit 1264 may include, for example and without limitation, an audio coder/decoder (“codec”) and a class D amplifier. In at least one embodiment, SIM card (“SIM”) 1257 may be communicatively coupled to WWAN unit 1256. In at least one embodiment, components such as WLAN unit 1250 and Bluetooth unit 1252, as well as WWAN unit 1256 may be implemented in a Next Generation Form Factor (“NGFF”).

Inference and/or training logic 915 are used to perform inferencing and/or training operations associated with one or more embodiments. Details regarding inference and/or training logic 915 are provided below in conjunction with FIGS. 9A and/or 9B. In at least one embodiment, inference and/or training logic 915 may be used in system FIG. 12 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

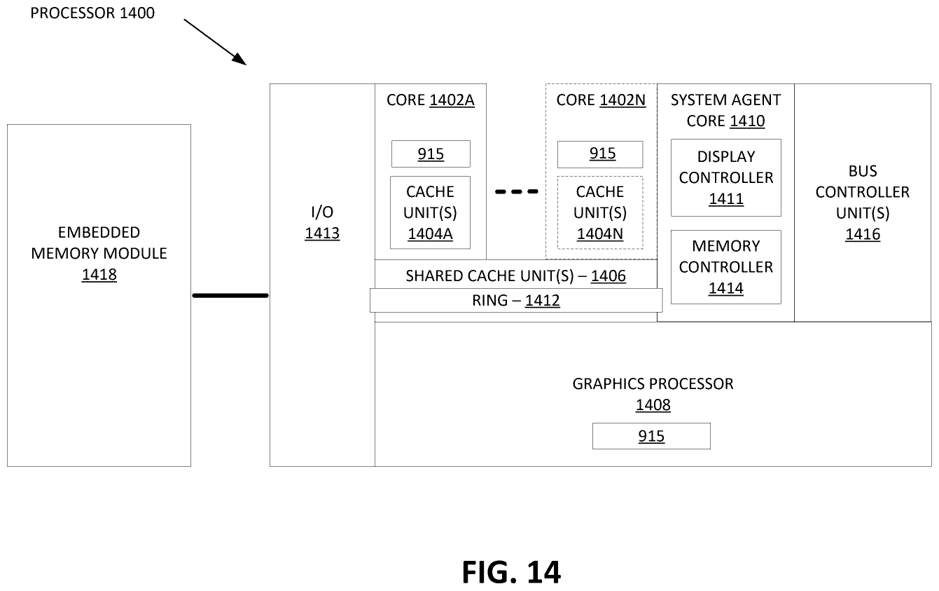

FIG. 13 is a block diagram of a processing system 1300, according to at least one embodiment. For example, processing system 1300 can correspond to the audio processing server 120, and/or the devices 112-2, . . . , 112-N of FIG. 1 in embodiments. In at least one embodiment, system 1300 includes one or more processors 1302 and one or more graphics processors 1308, and may be a single processor desktop system, a multiprocessor workstation system, or a server system having a large number of processors 1302 or processor cores 1307. In at least one embodiment, system 1300 is a processing platform incorporated within a system-on-a-chip (SoC) integrated circuit for use in mobile, handheld, edge, or embedded devices.

In at least one embodiment, system 1300 may include, or be incorporated within a server-based gaming platform, a game console, including a game and media console, a mobile gaming console, a handheld game console, or an online game console. In at least one embodiment, system 1300 is a mobile phone, smart phone, tablet computing device or mobile Internet device. In at least one embodiment, processing system 1300 may also include, couple with, or be integrated within a wearable device, such as a smart watch wearable device, smart eyewear device, augmented reality device, or virtual reality device. In at least one embodiment, processing system 1300 is a television or set top box device having one or more processors 1302 and a graphical interface generated by one or more graphics processors 1308.

In at least one embodiment, one or more processors 1302 each include one or more processor cores 1307 to process instructions which, when executed, perform operations for system and user software. In at least one embodiment, each of one or more processor cores 1307 is configured to process a specific instruction set 1309. In at least one embodiment, instruction set 1309 may facilitate Complex Instruction Set Computing (CISC), Reduced Instruction Set Computing (RISC), or computing via a Very Long Instruction Word (VLIW). In at least one embodiment, processor cores 1307 may each process a different instruction set 1309, which may include instructions to facilitate emulation of other instruction sets. In at least one embodiment, processor core 1307 may also include other processing devices, such a Digital Signal Processor (DSP).

In at least one embodiment, processor 1302 includes cache memory 1304. In at least one embodiment, processor 1302 may have a single internal cache or multiple levels of internal cache. In at least one embodiment, cache memory is shared among various components of processor 1302. In at least one embodiment, processor 1302 also uses an external cache (e.g., a Level-3 (L3) cache or Last Level Cache (LLC)) (not shown), which may be shared among processor cores 1307 using known cache coherency techniques. In at least one embodiment, register file 1306 is additionally included in processor 1302 which may include different types of registers for storing different types of data (e.g., integer registers, floating point registers, status registers, and an instruction pointer register). In at least one embodiment, register file 1306 may include general-purpose registers or other registers.

In at least one embodiment, one or more processor(s) 1302 are coupled with one or more interface bus(es) 1310 to transmit communication signals such as address, data, or control signals between processor 1302 and other components in system 1300. In at least one embodiment, interface bus 1310, in one embodiment, may be a processor bus, such as a version of a Direct Media Interface (DMI) bus. In at least one embodiment, interface 1310 is not limited to a DMI bus, and may include one or more Peripheral Component Interconnect buses (e.g., PCI, PCI Express), memory busses, or other types of interface busses. In at least one embodiment processor(s) 1302 include an integrated memory controller 1316 and a platform controller hub 1330. In at least one embodiment, memory controller 1316 facilitates communication between a memory device and other components of system 1300, while platform controller hub (PCH) 1330 provides connections to I/O devices via a local I/O bus.

In at least one embodiment, memory device 1320 may be a dynamic random access memory (DRAM) device, a static random access memory (SRAM) device, flash memory device, phase-change memory device, or some other memory device having suitable performance to serve as process memory. In at least one embodiment memory device 1320 may operate as system memory for system 1300, to store data 1322 and instructions 1321 for use when one or more processors 1302 executes an application or process. In at least one embodiment, memory controller 1316 also couples with an optional external graphics processor 1312, which may communicate with one or more graphics processors 1308 in processors 1302 to perform graphics and media operations. In at least one embodiment, a display device 1311 may connect to processor(s) 1302. In at least one embodiment display device 1311 may include one or more of an internal display device, as in a mobile electronic device or a laptop device or an external display device attached via a display interface (e.g., DisplayPort, etc.). In at least one embodiment, display device 1311 may include a head mounted display (HMD) such as a stereoscopic display device for use in virtual reality (VR) applications or augmented reality (AR) applications.

In at least one embodiment, platform controller hub 1330 enables peripherals to connect to memory device 1320 and processor 1302 via a high-speed I/O bus. In at least one embodiment, I/O peripherals include, but are not limited to, an audio controller 1346, a network controller 1334, a firmware interface 1328, a wireless transceiver 1326, touch sensors 1325, a data storage device 1324 (e.g., hard disk drive, flash memory, etc.). In at least one embodiment, data storage device 1324 may connect via a storage interface (e.g., SATA) or via a peripheral bus, such as a Peripheral Component Interconnect bus (e.g., PCI, PCI Express). In at least one embodiment, touch sensors 1325 may include touch screen sensors, pressure sensors, or fingerprint sensors. In at least one embodiment, wireless transceiver 1326 may be a Wi-Fi transceiver, a Bluetooth transceiver, or a mobile network transceiver such as a 3G, 4G, or Long Term Evolution (LTE) transceiver. In at least one embodiment, firmware interface 1328 enables communication with system firmware, and may be, for example, a unified extensible firmware interface (UEFI). In at least one embodiment, network controller 1334 may enable a network connection to a wired network. In at least one embodiment, a high-performance network controller (not shown) couples with interface bus 1310. In at least one embodiment, audio controller 1346 is a multi-channel high definition audio controller. In at least one embodiment, system 1300 includes an optional legacy I/O controller 1340 for coupling legacy (e.g., Personal System 2 (PS/2)) devices to system. In at least one embodiment, platform controller hub 1330 may also connect to one or more Universal Serial Bus (USB) controllers 1342 connect input devices, such as keyboard and mouse 1343 combinations, a camera 1344, or other USB input devices.

In at least one embodiment, an instance of memory controller 1316 and platform controller hub 1330 may be integrated into a discreet external graphics processor, such as external graphics processor 1312. In at least one embodiment, platform controller hub 1330 and/or memory controller 1316 may be external to one or more processor(s) 1302. For example, in at least one embodiment, system 1300 may include an external memory controller 1316 and platform controller hub 1330, which may be configured as a memory controller hub and peripheral controller hub within a system chipset that is in communication with processor(s) 1302.

Inference and/or training logic 915 are used to perform inferencing and/or training operations associated with one or more embodiments. Details regarding inference and/or training logic 915 are provided below in conjunction with FIGS. 9A and/or 9B. In at least one embodiment portions or all of inference and/or training logic 915 may be incorporated into graphics processor 1300. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 9A or 9B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

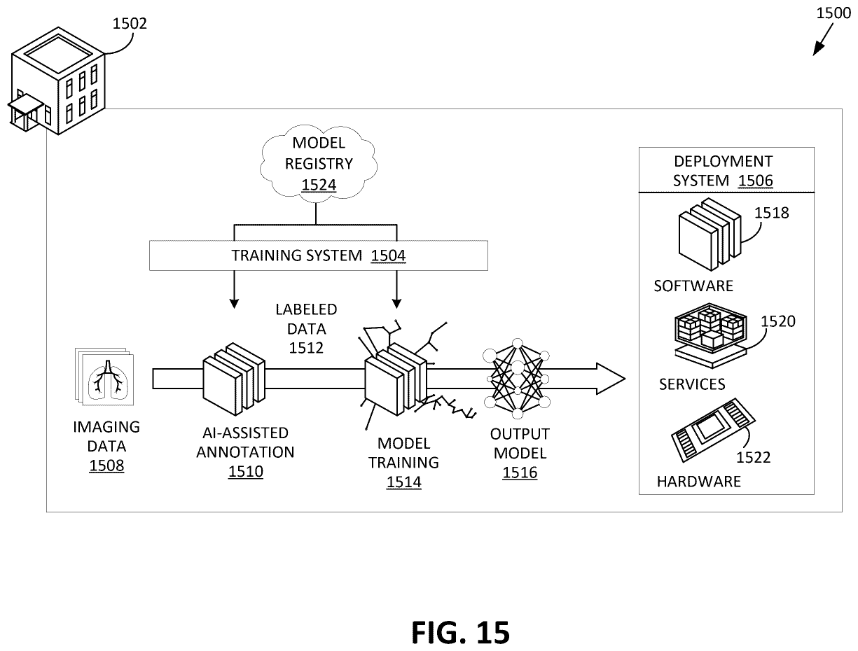

FIG. 14 is a block diagram of a processor 1400 having one or more processor cores 1402A-1402N, an integrated memory controller 1414, and an integrated graphics processor 1408, according to at least one embodiment. For example, processor 1400 may be included in, or otherwise accessed by the audio processing server 120, and/or the devices 112-2, . . . , 112-N, of FIG. 1, in embodiments. In at least one embodiment, processor 1400 may include additional cores up to and including additional core 1402N represented by dashed lined boxes. In at least one embodiment, each of processor cores 1402A-1402N includes one or more internal cache units 1404A-1404N. In at least one embodiment, each processor core also has access to one or more shared cached units 1406.

In at least one embodiment, internal cache units 1404A-1404N and shared cache units 1406 represent a cache memory hierarchy within processor 1400. In at least one embodiment, cache memory units 1404A-1404N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1406 and 1404A-1404N.

In at least one embodiment, processor 1400 may also include a set of one or more bus controller units 1416 and a system agent core 1410. In at least one embodiment, one or more bus controller units 1416 manage a set of peripheral buses, such as one or more PCI or PCI express busses. In at least one embodiment, system agent core 1410 provides management functionality for various processor components. In at least one embodiment, system agent core 1410 includes one or more integrated memory controllers 1414 to manage access to various external memory devices (not shown).

In at least one embodiment, one or more of processor cores 1402A-1402N include support for simultaneous multi-threading. In at least one embodiment, system agent core 1410 includes components for coordinating and operating cores 1402A-1402N during multi-threaded processing. In at least one embodiment, system agent core 1410 may additionally include a power control unit (PCU), which includes logic and components to regulate one or more power states of processor cores 1402A-1402N and graphics processor 1408.

In at least one embodiment, processor 1400 additionally includes graphics processor 1408 to execute graphics processing operations. In at least one embodiment, graphics processor 1408 couples with shared cache units 1406, and system agent core 1410, including one or more integrated memory controllers 1414. In at least one embodiment, system agent core 1410 also includes a display controller 1411 to drive graphics processor output to one or more coupled displays. In at least one embodiment, display controller 1411 may also be a separate module coupled with graphics processor 1408 via at least one interconnect or may be integrated within graphics processor 1408.

In at least one embodiment, a ring based interconnect unit 1412 is used to couple internal components of processor 1400. In at least one embodiment, an alternative interconnect unit may be used, such as a point-to-point interconnect, a switched interconnect, or other techniques. In at least one embodiment, graphics processor 1408 couples with ring interconnect 1412 via an I/O link 1413.

In at least one embodiment, I/O link 1413 represents at least one of multiple varieties of I/O interconnects, including an on package I/O interconnect which facilitates communication between various processor components and a high-performance embedded memory module 1418, such as an eDRAM module. In at least one embodiment, each of processor cores 1402A-1402N and graphics processor 1408 use embedded memory modules 1418 as a shared Last Level Cache.

In at least one embodiment, processor cores 1402A-1402N are homogenous cores executing a common instruction set architecture. In at least one embodiment, processor cores 1402A-1402N are heterogeneous in terms of instruction set architecture (ISA), where one or more of processor cores 1402A-1402N execute a common instruction set, while one or more other cores of processor cores 1402A-1402N executes a subset of a common instruction set or a different instruction set. In at least one embodiment, processor cores 1402A-1402N are heterogeneous in terms of microarchitecture, where one or more cores having a relatively higher power consumption couple with one or more power cores having a lower power consumption. In at least one embodiment, processor 1400 may be implemented on one or more chips or as an SoC integrated circuit.

Inference and/or training logic 915 are used to perform inferencing and/or training operations associated with one or more embodiments. Details regarding inference and/or training logic 915 are provided below in conjunction with FIGS. 9A and/or 9B. In at least one embodiment portions or all of inference and/or training logic 915 may be incorporated into processor 1400. For example, in at least one embodiment, training and/or inferencing techniques described herein may use one or more of ALUs embodied in graphics processor 1408, graphics core(s) 1402A-1402N, or other components in FIG. 14. Moreover, in at least one embodiment, inferencing and/or training operations described herein may be done using logic other than logic illustrated in FIG. 9A or 9B. In at least one embodiment, weight parameters may be stored in on-chip or off-chip memory and/or registers (shown or not shown) that configure ALUs of graphics processor 1400 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

### Virtualized Computing Platform

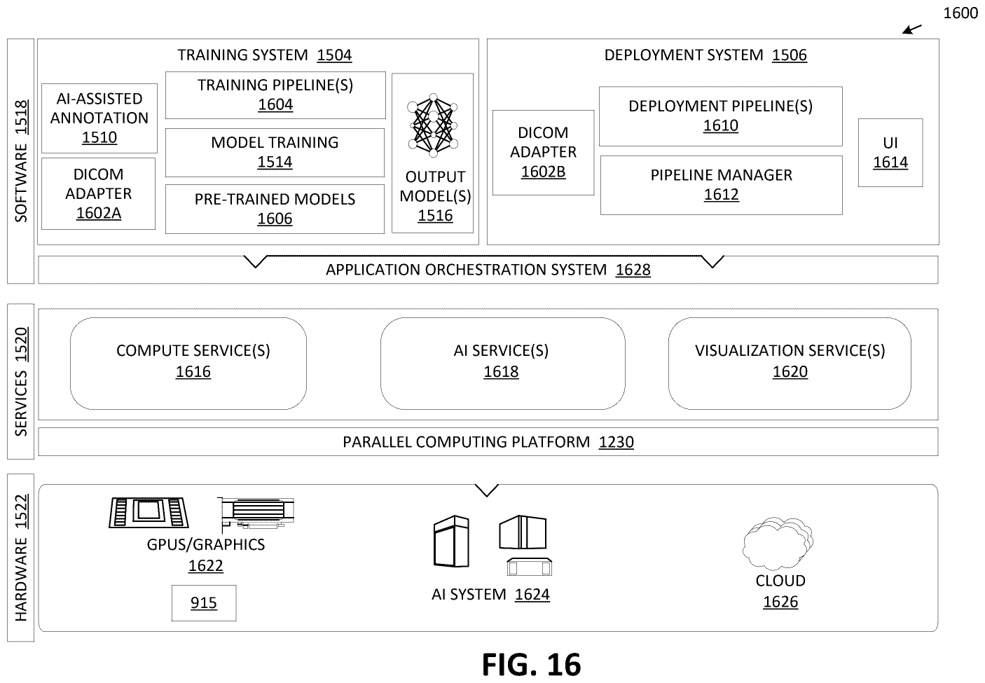

FIG. 15 is an example data flow diagram for a process 1500 of generating and deploying an image processing and inferencing pipeline, in accordance with at least one embodiment, such as with regards to the generation of animation data as described herein. In at least one embodiment, process 1500 may be deployed for use with imaging devices, processing devices, and/or other device types at one or more facilities 1502. Process 1500 may be executed within a training system 1504 and/or a deployment system 1506. In at least one embodiment, training system 1504 may be used to perform training, deployment, and implementation of machine learning models (e.g., neural networks, object detection algorithms, computer vision algorithms, etc.) for use in deployment system 1506. In at least one embodiment, deployment system 1506 may be configured to offload processing and compute resources among a distributed computing environment to reduce infrastructure requirements at facility 1502. In at least one embodiment, one or more applications in a pipeline may use or call upon services (e.g., inference, visualization, compute, AI, etc.) of deployment system 1506 during execution of applications.

In at least one embodiment, some of applications used in advanced processing and inferencing pipelines may use machine learning models or other AI to perform one or more processing steps. In at least one embodiment, machine learning models may be trained at facility 1502 using data 1508 (such as imaging data) generated at facility 1502 (and stored on one or more picture archiving and communication system (PACS) servers at facility 1502), may be trained using imaging or sequencing data 1508 from another facility (facilities), or a combination thereof. In at least one embodiment, training system 1504 may be used to provide applications, services, and/or other resources for generating working, deployable machine learning models for deployment system 1506.

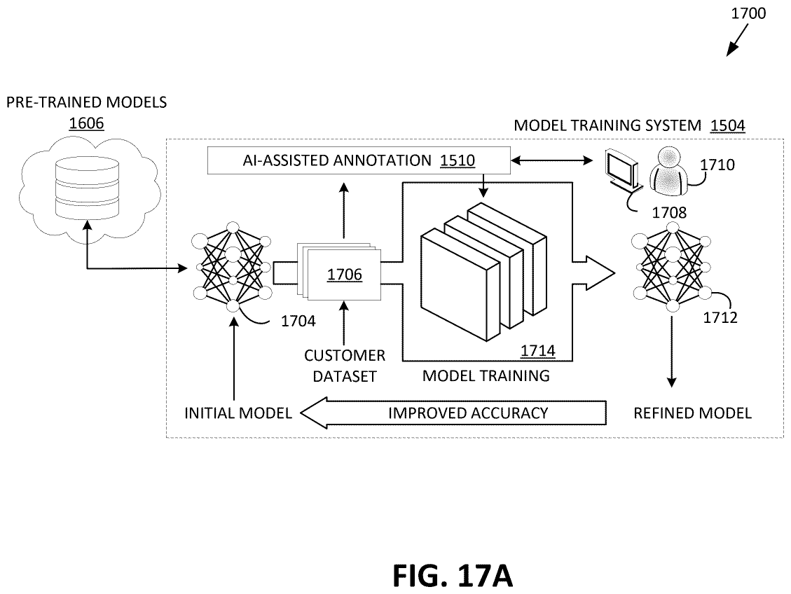

In at least one embodiment, model registry 1524 may be backed by object storage that may support versioning and object metadata. In at least one embodiment, object storage may be accessible through, for example, a cloud storage (e.g., cloud 1626 of FIG. 16) compatible application programming interface (API) from within a cloud platform. In at least one embodiment, machine learning models within model registry 1524 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1604 (FIG. 16) may include a scenario where facility 1102 is training their own machine learning model or has an existing machine learning model that needs to be optimized or updated. In at least one embodiment, imaging data 1508 generated by imaging device(s), sequencing devices, and/or other device types may be received. In at least one embodiment, once imaging data 1508 is received, AI-assisted annotation 1510 may be used to aid in generating annotations corresponding to imaging data 1508 to be used as ground truth data for a machine learning model. In at least one embodiment, AI-assisted annotation 1510 may include one or more machine learning models (e.g., convolutional neural networks (CNNs)) that may be trained to generate annotations corresponding to certain types of imaging data 1508 (e.g., from certain devices). In at least one embodiment, AI-assisted annotations 1510 may then be used directly, or may be adjusted or fine-tuned using an annotation tool to generate ground truth data. In at least one embodiment, AI-assisted annotations 1510, labeled clinic data 1512, or a combination thereof may be used as ground truth data for training a machine learning model. In at least one embodiment, a trained machine learning model may be referred to as output model 1516, and may be used by deployment system 1506, as described herein.

In at least one embodiment, training pipeline 1604 (FIG. 16) may include a scenario where facility 1502 needs a machine learning model for use in performing one or more processing tasks for one or more applications in deployment system 1506, but facility 1502 may not currently have such a machine learning model (or may not have a model that is optimized, efficient, or effective for such purposes). In at least one embodiment, an existing machine learning model may be selected from a model registry 1524. In at least one embodiment, model registry 1524 may include machine learning models trained to perform a variety of different inference tasks on imaging data. In at least one embodiment, machine learning models in model registry 1524 may have been trained on imaging data from different facilities than facility 1502 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1524. In at least one embodiment, a machine learning model may then be retrained, or updated, at any number of other facilities, and a retrained or updated model may be made available in model registry 1524. In at least one embodiment, a machine learning model may then be selected from model registry 1524—and referred to as output model 1516—and may be used in deployment system 1506 to perform one or more processing tasks for one or more applications of a deployment system.

In at least one embodiment, training pipeline 1604 (FIG. 16), a scenario may include facility 1502 requiring a machine learning model for use in performing one or more processing tasks for one or more applications in deployment system 1506, but facility 1502 may not currently have such a machine learning model (or may not have a model that is optimized, efficient, or effective for such purposes). In at least one embodiment, a machine learning model selected from model registry 1524 may not be fine-tuned or optimized for imaging data 1508 generated at facility 1502 because of differences in populations, robustness of training data used to train a machine learning model, diversity in anomalies of training data, and/or other issues with training data. In at least one embodiment, AI-assisted annotation 1510 may be used to aid in generating annotations corresponding to imaging data 1508 to be used as ground truth data for retraining or updating a machine learning model. In at least one embodiment, labeled data 1512 may be used as ground truth data for training a machine learning model. In at least one embodiment, retraining or updating a machine learning model may be referred to as model training 1514. In at least one embodiment, model training 1514—e.g., AI-assisted annotations 1510, labeled clinic data 1512, or a combination thereof—may be used as ground truth data for retraining or updating a machine learning model. In at least one embodiment, a trained machine learning model may be referred to as output model 1516, and may be used by deployment system 1506, as described herein.

In at least one embodiment, deployment system 1506 may include software 1518, services 1520, hardware 1522, and/or other components, features, and functionality. In at least one embodiment, deployment system 1506 may include a software “stack,” such that software 1518 may be built on top of services 1520 and may use services 1520 to perform some or all of processing tasks, and services 1520 and software 1518 may be built on top of hardware 1522 and use hardware 1522 to execute processing, storage, and/or other compute tasks of deployment system 1506. In at least one embodiment, software 1518 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1508, in addition to containers that receive and configure imaging data for use by each container and/or for use by facility 1502 after processing through a pipeline (e.g., to convert outputs back to a usable data type). In at least one embodiment, a combination of containers within software 1518 (e.g., that make up a pipeline) may be referred to as a virtual instrument (as described in more detail herein), and a virtual instrument may leverage services 1520 and hardware 1522 to execute some or all processing tasks of applications instantiated in containers.

In at least one embodiment, a data processing pipeline may receive input data (e.g., imaging data 1508) in a specific format in response to an inference request (e.g., a request from a user of deployment system 1506). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1516 of training system 1504.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1524 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, ctc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1520 as a system (e.g., system 1600 of FIG. 16). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1600 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1600 of FIG. 16). In at least one embodiment, completed and validated applications or containers may be stored in a container registry and associated machine learning models may be stored in model registry 1524. In at least one embodiment, a requesting entity—who provides an inference or image processing request—may browse a container registry and/or model registry 1524 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1506 (e.g., a cloud) to perform processing of data processing pipeline. In at least one embodiment, processing by deployment system 1506 may include referencing selected elements (e.g., applications, containers, models, etc.) from a container registry and/or model registry 1524. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1520 may be leveraged. In at least one embodiment, services 1520 may include compute services, artificial intelligence (AI) services, visualization services, and/or other service types. In at least one embodiment, services 1520 may provide functionality that is common to one or more applications in software 1518, so functionality may be abstracted to a service that may be called upon or leveraged by applications. In at least one embodiment, functionality provided by services 1520 may run dynamically and more efficiently, while also scaling well by allowing applications to process data in parallel (e.g., using a parallel computing platform 1630 (FIG. 16)). In at least one embodiment, rather than each application that shares a same functionality offered by a service 1520 being required to have a respective instance of service 1520, service 1520 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects-such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1520 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1518 implementing advanced processing and inferencing pipeline that includes segmentation application and anomaly detection application may be streamlined because each application may call upon a same inference service to perform one or more inferencing tasks.

In at least one embodiment, hardware 1522 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1522 may be used to provide efficient, purpose-built support for software 1518 and services 1520 in deployment system 1506. In at least one embodiment, use of GPU processing may be implemented for processing locally (e.g., at facility 1502), within an AI/deep learning system, in a cloud system, and/or in other processing components of deployment system 1506 to improve efficiency, accuracy, and efficacy of image processing and generation. In at least one embodiment, software 1518 and/or services 1520 may be optimized for GPU processing with respect to deep learning, machine learning, and/or high-performance computing, as non-limiting examples. In at least one embodiment, at least some of computing environment of deployment system 1506 and/or training system 1504 may be executed in a datacenter one or more supercomputers or high performance computing systems, with GPU optimized software (e.g., hardware and software combination of NVIDIA's DGX System). In at least one embodiment, hardware 1522 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 16 is a system diagram for an example system 1600 for generating and deploying an imaging deployment pipeline, in accordance with at least one embodiment, such as with regards to the generation of animation data as described herein. In at least one embodiment, system 1600 may be used to implement process 1500 of FIG. 15 and/or other processes including advanced processing and inferencing pipelines. In at least one embodiment, system 1600 may include training system 1504 and deployment system 1506. In at least one embodiment, training system 1504 and deployment system 1506 may be implemented using software 1518, services 1520, and/or hardware 1522, as described herein.

In at least one embodiment, system 1600 (e.g., training system 1504 and/or deployment system 1506) may implemented in a cloud computing environment (e.g., using cloud 1626). In at least one embodiment, system 1600 may be implemented locally with respect to a healthcare services facility, or as a combination of both cloud and local computing resources. In at least one embodiment, access to APIs in cloud 1626 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1600, may be restricted to a set of public IPs that have been vetted or authorized for interaction.

In at least one embodiment, various components of system 1600 may communicate between and among one another using any of a variety of different network types, including but not limited to local area networks (LANs) and/or wide area networks (WANs) via wired and/or wireless communication protocols. In at least one embodiment, communication between facilities and components of system 1600 (e.g., for transmitting inference requests, for receiving results of inference requests, etc.) may be communicated over data bus (ses), wireless data protocols (Wi-Fi), wired data protocols (e.g., Ethernet), etc.

In at least one embodiment, training system 1504 may execute training pipelines 1604, similar to those described herein with respect to FIG. 15. In at least one embodiment, where one or more machine learning models are to be used in deployment pipelines 1610 by deployment system 1506, training pipelines 1604 may be used to train or retrain one or more (e.g. pre-trained) models, and/or implement one or more of pre-trained models 1606 (e.g., without a need for retraining or updating). In at least one embodiment, as a result of training pipelines 1604, output model(s) 1516 may be generated. In at least one embodiment, training pipelines 1604 may include any number of processing steps, such as but not limited to imaging data (or other input data) conversion or adaption In at least one embodiment, for different machine learning models used by deployment system 1506, different training pipelines 1604 may be used. In at least one embodiment, training pipeline 1604 similar to a first example described with respect to FIG. 15 may be used for a first machine learning model, training pipeline 1604 similar to a second example described with respect to FIG. 15 may be used for a second machine learning model, and training pipeline 1604 similar to a third example described with respect to FIG. 15 may be used for a third machine learning model. In at least one embodiment, any combination of tasks within training system 1504 may be used depending on what is required for each respective machine learning model. In at least one embodiment, one or more of machine learning models may already be trained and ready for deployment so machine learning models may not undergo any processing by training system 1504 and may be implemented by deployment system 1506.

In at least one embodiment, output model(s) 1516 and/or pre-trained model(s) 1606 may include any types of machine learning models depending on implementation or embodiment. In at least one embodiment, and without limitation, machine learning models used by system 1600 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

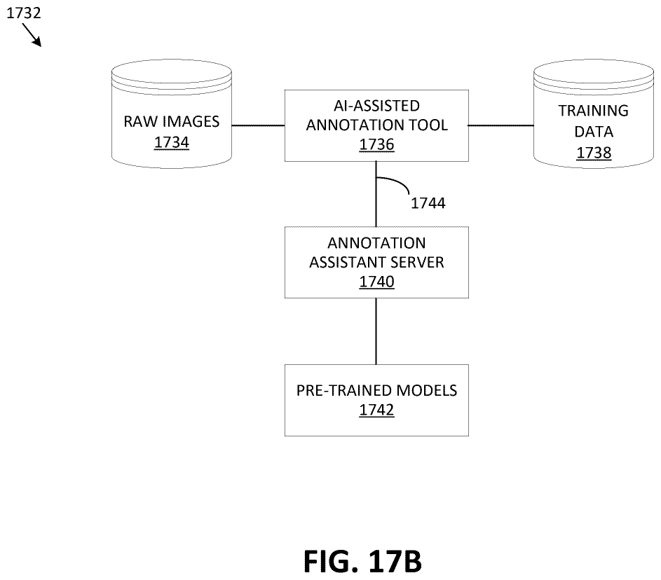

In at least one embodiment, training pipelines 1604 may include AI-assisted annotation, as described in more detail herein with respect to at least FIG. 17B. In at least one embodiment, labeled data 1512 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1508 (or other data type used by machine learning models), there may be corresponding ground truth data generated by training system 1504. In at least one embodiment, AI-assisted annotation may be performed as part of deployment pipelines 1610; cither in addition to, or in lieu of AI-assisted annotation included in training pipelines 1604. In at least one embodiment, system 1600 may include a multi-layer platform that may include a software layer (e.g., software 1518) of diagnostic applications (or other application types) that may perform one or more medical imaging and diagnostic functions. In at least one embodiment, system 1600 may be communicatively coupled to (e.g., via encrypted links) PACS server networks of one or more facilities. In at least one embodiment, system 1600 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1502). In at least one embodiment, applications may then call or execute one or more services 1520 for performing compute, AI, or visualization tasks associated with respective applications, and software 1518 and/or services 1520 may leverage hardware 1522 to perform processing tasks in an effective and efficient manner.

In at least one embodiment, deployment system 1506 may execute deployment pipelines 1610. In at least one embodiment, deployment pipelines 1610 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1610 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1610 depending on information desired from data generated by a device. In at least one embodiment, where detections of anomalies are desired from an MRI machine, there may be a first deployment pipeline 1610, and where image enhancement is desired from output of an MRI machine, there may be a second deployment pipeline 1610.

In at least one embodiment, an image generation application may include a processing task that includes use of a machine learning model. In at least one embodiment, a user may desire to use their own machine learning model, or to select a machine learning model from model registry 1524. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1600—such as services 1520 and hardware 1522—deployment pipelines 1610 may be even more user friendly, provide for easier integration, and produce more accurate, efficient, and timely results.

In at least one embodiment, deployment system 1506 may include a user interface 1614 (e.g., a graphical user interface, a web interface, etc.) that may be used to select applications for inclusion in deployment pipeline(s) 1610, arrange applications, modify, or change applications or parameters or constructs thereof, use and interact with deployment pipeline(s) 1610 during set-up and/or deployment, and/or to otherwise interact with deployment system 1506. In at least one embodiment, although not illustrated with respect to training system 1504, user interface 1614 (or a different user interface) may be used for selecting models for use in deployment system 1506, for selecting models for training, or retraining, in training system 1504, and/or for otherwise interacting with training system 1504.

In at least one embodiment, pipeline manager 1612 may be used, in addition to an application orchestration system 1628, to manage interaction between applications or containers of deployment pipeline(s) 1610 and services 1520 and/or hardware 1522. In at least one embodiment, pipeline manager 1612 may be configured to facilitate interactions from application to application, from application to service 1520, and/or from application or service to hardware 1522. In at least one embodiment, although illustrated as included in software 1518, this is not intended to be limiting, and in some examples (e.g., as illustrated in FIG. 14) pipeline manager 1412 may be included in services 1520. In at least one embodiment, application orchestration system 1628 (e.g., Kubernetes, DOCKER, etc.) may include a container orchestration system that may group applications into containers as logical units for coordination, management, scaling, and deployment. In at least one embodiment, by associating applications from deployment pipeline(s) 1610 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1612 and application orchestration system 1628. In at least one embodiment, so long as an expected input and/or output of each container or application is known by a system (e.g., based on constructs of applications or containers), application orchestration system 1628 and/or pipeline manager 1612 may facilitate communication among and between, and sharing of resources among and between, each of applications or containers. In at least one embodiment, because one or more of applications or containers in deployment pipeline(s) 1610 may share same services and resources, application orchestration system 1628 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1628) may determine resource availability and distribution based on constraints imposed on a system (e.g., user constraints), such as quality of service (QOS), urgency of need for data outputs (e.g., to determine whether to execute real-time processing or delayed processing), etc.

In at least one embodiment, services 1520 leveraged by and shared by applications or containers in deployment system 1506 may include compute services 1616, AI services 1618, visualization services 1620, and/or other service types. In at least one embodiment, applications may call (e.g., execute) one or more of services 1520 to perform processing operations for an application. In at least one embodiment, compute services 1616 may be leveraged by applications to perform super-computing or other high-performance computing (HPC) tasks. In at least one embodiment, compute service(s) 1616 may be leveraged to perform parallel processing (e.g., using a parallel computing platform 1630) for processing data through one or more of applications and/or one or more tasks of a single application, substantially simultaneously. In at least one embodiment, parallel computing platform 1630 (e.g., NVIDIA's CUDA) may enable general purpose computing on GPUs (GPGPU) (e.g., GPUs 1622). In at least one embodiment, a software layer of parallel computing platform 1630 may provide access to virtual instruction sets and parallel computational elements of GPUs, for execution of compute kernels. In at least one embodiment, parallel computing platform 1630 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1630 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1618 may be leveraged to perform inferencing services for executing machine learning model(s) associated with applications (e.g., tasked with performing one or more processing tasks of an application). In at least one embodiment, AI services 1618 may leverage AI system 1624 to execute machine learning model(s) (e.g., neural networks, such as CNNs) for segmentation, reconstruction, object detection, feature detection, classification, and/or other inferencing tasks. In at least one embodiment, applications of deployment pipeline(s) 1610 may use one or more of output models 1516 from training system 1504 and/or other models of applications to perform inference on imaging data. In at least one embodiment, two or more examples of inferencing using application orchestration system 1628 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1628 may distribute resources (e.g., services 1520 and/or hardware 1522) based on priority paths for different inferencing tasks of AI services 1618.

In at least one embodiment, shared storage may be mounted to AI services 1618 within system 1600. In at least one embodiment, shared storage may operate as a cache (or other storage device type) and may be used to process inference requests from applications. In at least one embodiment, when an inference request is submitted, a request may be received by a set of API instances of deployment system 1506, and one or more instances may be selected (e.g., for best fit, for load balancing, etc.) to process a request. In at least one embodiment, to process a request, a request may be entered into a database, a machine learning model may be located from model registry 1524 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1612) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT <1 min) priority while others may have lower priority (e.g., TAT <11 min). In at least one embodiment, model execution times may be measured from requesting institution or entity and may include partner network traversal time, as well as execution on an inference service.

In at least one embodiment, transfer of requests between services 1520 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1626, and an inference service may perform inferencing on a GPU.

In at least one embodiment, visualization services 1620 may be leveraged to generate visualizations for viewing outputs of applications and/or deployment pipeline(s) 1610. In at least one embodiment, GPUs 1622 may be leveraged by visualization services 1620 to generate visualizations. In at least one embodiment, rendering effects, such as ray-tracing, may be implemented by visualization services 1620 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1620 may include an internal visualizer, cinematics, and/or other rendering or image processing capabilities or functionality (e.g., ray tracing, rasterization, internal optics, etc.).

In at least one embodiment, hardware 1522 may include GPUs 1622, AI system 1624, cloud 1626, and/or any other hardware used for executing training system 1504 and/or deployment system 1506. In at least one embodiment, GPUs 1622 (e.g., NVIDIA's TESLA and/or QUADRO GPUs) may include any number of GPUs that may be used for executing processing tasks of compute services 1616, AI services 1618, visualization services 1620, other services, and/or any of features or functionality of software 1518. For example, with respect to AI services 1618, GPUs 1622 may be used to perform pre-processing on imaging data (or other data types used by machine learning models), post-processing on outputs of machine learning models, and/or to perform inferencing (e.g., to execute machine learning models). In at least one embodiment, cloud 1626, AI system 1624, and/or other components of system 1600 may use GPUs 1622. In at least one embodiment, cloud 1626 may include a GPU-optimized platform for deep learning tasks. In at least one embodiment, AI system 1624 may use GPUs, and cloud 1626—or at least a portion tasked with deep learning or inferencing—may be executed using one or more AI systems 1624. As such, although hardware 1522 is illustrated as discrete components, this is not intended to be limiting, and any components of hardware 1522 may be combined with, or leveraged by, any other components of hardware 1522.

In at least one embodiment, AI system 1624 may include a purpose-built computing system (e.g., a super-computer or an HPC) configured for inferencing, deep learning, machine learning, and/or other artificial intelligence tasks. In at least one embodiment, AI system 1624 (e.g., NVIDIA's DGX) may include GPU-optimized software (e.g., a software stack) that may be executed using a plurality of GPUs 1622, in addition to DPUs, CPUs, RAM, storage, and/or other components, features, or functionality. In at least one embodiment, one or more AI systems 1624 may be implemented in cloud 1626 (e.g., in a data center) for performing some or all of AI-based processing tasks of system 1600.

In at least one embodiment, cloud 1626 may include a GPU-accelerated infrastructure (e.g., NVIDIA's NGC) that may provide a GPU-optimized platform for executing processing tasks of system 1600. In at least one embodiment, cloud 1626 may include an AI system(s) 1624 for performing one or more of AI-based tasks of system 1600 (e.g., as a hardware abstraction and scaling platform). In at least one embodiment, cloud 1626 may integrate with application orchestration system 1628 leveraging multiple GPUs to enable seamless scaling and load balancing between and among applications and services 1520. In at least one embodiment, cloud 1626 may tasked with executing at least some of services 1520 of system 1600, including compute services 1616, AI services 1618, and/or visualization services 1620, as described herein. In at least one embodiment, cloud 1626 may perform small and large batch inference (e.g., executing NVIDIA's TENSOR RT), provide an accelerated parallel computing API and platform 1630 (e.g., NVIDIA's CUDA), execute application orchestration system 1628 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1600.

FIG. 17A illustrates a data flow diagram for a process 1700 to train, retrain, or update a machine learning model, in accordance with at least one embodiment, such as with regards to generating animation data from audio data. In at least one embodiment, process 1700 may be executed using, as a non-limiting example, system 1600 of FIG. 16. In at least one embodiment, process 1700 may leverage services 1520 and/or hardware 1522 of system 1600, as described herein. In at least one embodiment, refined models 1712 generated by process 1700 may be executed by deployment system 1506 for one or more containerized applications in deployment pipelines 1610.

In at least one embodiment, model training 1514 may include retraining or updating an initial model 1704 (e.g., a pre-trained model) using new training data (e.g., new input data, such as customer dataset 1706, and/or new ground truth data associated with input data). In at least one embodiment, to retrain, or update, initial model 1704, output or loss layer(s) of initial model 1704 may be reset, or deleted, and/or replaced with an updated or new output or loss layer(s). In at least one embodiment, initial model 1704 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1704, parameters may be updated and re-tuned for a new data set based on loss calculations associated with accuracy of output or loss layer(s) at generating predictions on new, customer dataset 1706 (e.g., image data 1508 of FIG. 15).

In at least one embodiment, pre-trained models 1606 may be stored in a data store, or registry (e.g., model registry 1524 of FIG. 15). In at least one embodiment, pre-trained models 1206 may have been trained, at least in part, at one or more facilities other than a facility executing process 1700. In at least one embodiment, to protect privacy and rights of patients, subjects, or clients of different facilities, pre-trained models 1606 may have been trained, on-premise, using customer or patient data generated on-premise. In at least one embodiment, pre-trained models 1606 may be trained using cloud 1626 and/or other hardware 1522, but confidential, privacy protected patient data may not be transferred to, used by, or accessible to any components of cloud 1626 (or other off premise hardware). In at least one embodiment, where a pre-trained model 1606 is trained at using patient data from more than one facility, pre-trained model 1606 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1606 on-premise and/or off premise, such as in a datacenter or other cloud computing infrastructure.

In at least one embodiment, when selecting applications for use in deployment pipelines 1610, a user may also select machine learning models to be used for specific applications. In at least one embodiment, a user may not have a model for use, so a user may select a pre-trained model 1606 to use with an application. In at least one embodiment, pre-trained model 1606 may not be optimized for generating accurate results on customer dataset 1706 of a facility of a user (e.g., based on patient diversity, demographics, types of medical imaging devices used, etc.). In at least one embodiment, prior to deploying pre-trained model 1606 into deployment pipeline 1610 for use with an application(s), pre-trained model 1606 may be updated, retrained, and/or fine-tuned for use at a respective facility.

In at least one embodiment, a user may select pre-trained model 1606 that is to be updated, retrained, and/or fine-tuned, and pre-trained model 1606 may be referred to as initial model 1704 for training system 1504 within process 1700. In at least one embodiment, customer dataset 1706 (e.g., imaging data, genomics data, sequencing data, or other data types generated by devices at a facility) may be used to perform model training 1514 (which may include, without limitation, transfer learning) on initial model 1704 to generate refined model 1712. In at least one embodiment, ground truth data corresponding to customer dataset 1706 may be generated by training system 1504. In at least one embodiment, ground truth data may be generated, at least in part, by clinicians, scientists, doctors, practitioners, at a facility (e.g., as labeled clinic data 1512 of FIG. 15).

In at least one embodiment, AI-assisted annotation 1510 may be used in some examples to generate ground truth data. In at least one embodiment, AI-assisted annotation 1510 (e.g., implemented using an AI-assisted annotation SDK) may leverage machine learning models (e.g., neural networks) to generate suggested or predicted ground truth data for a customer dataset. In at least one embodiment, user 1710 may use annotation tools within a user interface (a graphical user interface (GUI)) on computing device 1708.

In at least one embodiment, user 1710 may interact with a GUI via computing device 1708 to edit or fine-tune (auto) annotations. In at least one embodiment, a polygon editing feature may be used to move vertices of a polygon to more accurate or fine-tuned locations.

In at least one embodiment, once customer dataset 1706 has associated ground truth data, ground truth data (e.g., from AI-assisted annotation, manual labeling, etc.) may be used by during model training 1514 to generate refined model 1712. In at least one embodiment, customer dataset 1706 may be applied to initial model 1704 any number of times, and ground truth data may be used to update parameters of initial model 1704 until an acceptable level of accuracy is attained for refined model 1712. In at least one embodiment, once refined model 1712 is generated, refined model 1712 may be deployed within one or more deployment pipelines 1610 at a facility for performing one or more processing tasks with respect to medical imaging data.

In at least one embodiment, refined model 1712 may be uploaded to pre-trained models 1606 in model registry 1524 to be selected by another facility. In at least one embodiment, his process may be completed at any number of facilities such that refined model 1712 may be further refined on new datasets any number of times to generate a more universal model.

FIG. 17B is an example illustration of a client-server architecture 1732 to enhance annotation tools with pre-trained annotation models, in accordance with at least one embodiment, such as with regards to generating animation data from audio data. In at least one embodiment, AI-assisted annotation tools 1736 may be instantiated based on a client-server architecture 1732. In at least one embodiment, annotation tools 1736 in imaging applications may aid radiologists, for example, identify organs and abnormalities. In at least one embodiment, imaging applications may include software tools that help user 1710 to identify, as a non-limiting example, a few extreme points on a particular organ of interest in raw images 1734 (e.g., in a 3D MRI or CT scan) and receive auto-annotated results for all 2D slices of a particular organ. In at least one embodiment, results may be stored in a data store as training data 1738 and used as (for example and without limitation) ground truth data for training. In at least one embodiment, when computing device 1708 sends extreme points for AI-assisted annotation 1510, a deep learning model, for example, may receive this data as input and return inference results of a segmented organ or abnormality. In at least one embodiment, pre-instantiated annotation tools, such as AI-Assisted Annotation Tool 1736 in FIG. 17B, may be enhanced by making API calls (e.g., API Call 1744) to a server, such as an Annotation Assistant Server 1740 that may include a set of pre-trained models 1742 stored in an annotation model registry, for example. In at least one embodiment, an annotation model registry may store pre-trained models 1742 (e.g., machine learning models, such as deep learning models) that are pre-trained to perform AI-assisted annotation on a particular organ or abnormality. These models may be further updated by using training pipelines 1604. In at least one embodiment, pre-installed annotation tools may be improved over time as new labeled clinic data 1512 is added.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving a first audio stream associated with a first device and a second audio stream associated with a second device;
providing a first segment of the first audio stream concurrently with a second segment of the second audio stream as inputs to a first artificial intelligence (AI) model to obtain first emotion data and second emotion data;
providing a third segment of the first audio stream and the first emotion data concurrently with a fourth segment of the second audio stream and the second emotion data as inputs to a second AI model to obtain first face pose data and second face pose data; and
providing the first face pose data to the first device to cause the first device to generate an animation of the first face pose data that corresponds to the first audio stream and the second face pose data to the second device to cause the second device to generate an animation of the second face pose data that corresponds to the second audio stream.

2. The method of claim 1, wherein the first segment of the first audio stream and the second segment of the second audio stream correspond to a first window size and the third segment of the first audio stream and the fourth segment of the second audio stream correspond to a second window size.

3. The method of claim 2, wherein the first segment of the first audio stream is generated by one or more preprocessing operations.

4. The method of claim 3, wherein the one or more preprocessing operations comprise at least one of:
a resampling operation;
a rechunking operation; or
a converting operation.

5. The method of claim 1, further comprising:
storing the first emotion data in a data structure associated with the first audio stream; and
storing the second emotion data in a data structure associated with the second audio stream.

6. The method of claim 5, wherein the first emotion data has an associated timestamp based on the first segment of the first audio stream.

7. The method of claim 1, wherein the first segment of the first audio stream includes a first subsegment of silence at the beginning of the first segment.

8. The method of claim 7, wherein the first segment of the first audio stream further includes a second subsegment of silence at the end of the first segment.

9. The method of claim 1, further comprising:
providing a fifth segment of a third audio stream with default emotion data as inputs to the second AI model to obtain third face pose data; and
providing the third face pose data to a third device.

10. The method of claim 1, further comprising ensuring that any of the first audio stream, the first emotion data, or the first face pose data is inaccessible to the second device, and any of the second audio stream, the second emotion data, or the second face pose data is inaccessible to the first device.

11. A system comprising:
one or more processing devices to:
receive a first audio stream associated with a first device and a second audio stream associated with a second device;
provide a first segment of the first audio stream concurrently with a second segment of the second audio stream as inputs to aa first artificial intelligence (AI) model to obtain first emotion data and second emotion data;
provide a third segment of the first audio stream and the first emotion data concurrently with a fourth segment of the second audio stream and the second emotion data as inputs to a second AI model to obtain first face pose data and second face pose data; and
provide the first face pose data to the first device to cause the first device to generate an animation of the first face pose data that corresponds to the first audio stream and the second face pose data to the second device to cause the second device to generate an animation of the second face pose data that corresponds to the second audio stream.

12. The system of claim 11, wherein the first segment of the first audio stream and the second segment of the second audio stream correspond to a first window size and the third segment of the first audio stream and the fourth segment of the second audio stream correspond to a second window size.

13. The system of claim 12, wherein the first segment of the first audio stream is generated by one or more preprocessing operations.

14. The system of claim 13, wherein the one or more preprocessing operations comprise at least one of:
a resampling operation;
a rechunking operation; or
a converting operation.

15. The system of claim 11, wherein the one or more processing devices are further to:
store the first emotion data in a data structure associated with the first audio stream; and
store the second emotion data in a data structure associated with the second audio stream.

16. The system of claim 15, wherein the first emotion data has an associated timestamp based on the first segment of the first audio stream.

17. The system of claim 11, wherein the first segment of the first audio stream includes a first subsegment of silence at the beginning of the first segment.

18. The system of claim 17, wherein the first segment of the first audio stream further includes a second subsegment of silence at the end of the first segment.

19. The system of claim 11, wherein the one or more processing devices are further to:
provide a fifth segment of a third audio stream with default emotion data as inputs to the second AI model to obtain third face pose data; and
provide the third face pose data to a third device.

20. A processor comprising:
circuitry to cause a first device to generate an animation of first face pose data that corresponds to a first audio stream and to cause a second device to generate an animation of second face pose data that corresponds to a second audio stream, wherein a first segment of the first audio stream and a second segment of the second audio stream are provided as inputs to a first artificial intelligence (AI) model to obtain first emotion data and second emotion data, respectively, and the first emotion data and a third segment of the first audio stream are provided concurrently with the second emotion data and a fourth segment of the second audio stream to a second AI model to generate the first and second face pose data, respectively.
